(19) United States
(12) Patent Application Publication
(10) Pub. No.: US 2025/0362489 A1
(43) Pub. Date: Nov. 27, 2025

(54) PHASE DIVERSITY-BASED WAVEFRONT SENSING FOR FLUORESCENCE MICROSCOPY

(71) Applicant: Howard Hughes Medical Institute, Ashburn, VA (US)

(72) Inventors: Courtney Johnson, Ashburn, VA (US); Min Guo, Hangzhou (CN); Patrick J. La Riviere, Chicago, IL (US); Hari Shroff, Ashburn, VA (US); Magdalena Schneider, Ashburn, VA (US); Cedric Allier, Ashburn, VA (US)

(21) Appl. No.: 18/986,227

(22) Filed: Dec. 18, 2024

Related U.S. Application Data
(60) Provisional application No. 63/611,527, filed on Dec. 18, 2023.

(51) Int. Cl. G02B 21/36; G01N 21/64; G02B 21/16

(52) U.S. Cl. CPC G02B 21/365; G01N 21/6458; G02B 21/361; G02B 21/362; G02B 21/16

(57) ABSTRACT

A light beam is imaged within a sample and images of the sample are generated based on light received from the sample in response to the light imaged within the sample. A wavefront modulating element modifies a wavefront of the received light and/or a wavefront of the light imaged within the sample. One or more known aberrations are introduced into at least one image of the sample and, based on at least two images of the sample, where the images include a raw image and at least one image that includes a known aberration, an aberration of a wavefront of light emitted from, and/or provided to, the sample is estimated. The wavefront modulating element is controlled to modulate the wavefront of light emitted from, and/or provided to, the sample, such that the estimated aberration of the wavefront of light emitted from, and/or provided to, the sample is reduced.

### CROSS-REFERENCE TO RELATED APPLICATION

This application is a non-provisional of, and claims the benefit of, U.S. Provisional Application No. 63/611,527, filed on Dec. 18, 2023, entitled. “PHASE DIVERSITY BASED WAVEFRONT SENSING FOR FLUORESCENCE MICROSCOPY.” the disclosure of which is hereby incorporated by reference in its entirety.

### TECHNICAL FIELD

This disclosure relates generally to microscopy and, in particular, to fluorescence microscopy based on phase diversity-based wavefront sensing.

### BACKGROUND

Fluorescence microscopy is a valuable tool in biology, yet its performance is compromised when the wavefront of light is distorted due to imperfections of optical components of the imaging system or due to the refractile nature of the sample. Such optical aberrations can dramatically lower the information content of images by degrading image contrast, resolution, and signal. Adaptive optics methods (AO) can sense and subsequently cancel the aberrated wavefront, but can be complex, inefficient, slow, or expensive for routine adoption by most labs.

Fluorescence microscopy is valuable in biological research due to its contrast, resolution, speed, and potential for live imaging. However, the refractile nature of biological tissues or misaligned or imperfect optical elements of a microscope system often cause undesirable bending of illumination and emission light, introducing wavefront distortion. Such ‘optical aberrations’ prevent diffraction-limited focusing, lowering contrast, resolution, and signal in fluorescence images. For example, FIG. 1A is a schematic diagram of imaging an ideal fluorescent sample, in which spherical wavefronts 102 are captured from the sample and converted to parallel wavefronts 106 by the objective lens 104, yielding a flat wavefront 106 at the pupil plane having an unaberrated phase profile 108. However, in most real refractile samples, bending of light due to the sample yields a distorted wavefront with noticeable phase variation at the pupil. FIG. 1B is a schematic diagram of imaging a refractile sample, in which wavefronts 112 are captured from the sample and converted to wavefronts 116 by the objective lens 114, yielding an aberrated wavefront 116 at the pupil plane having an aberrated phase profile 118.

### SUMMARY

In some aspects, the techniques described herein relate to a microscope system for imaging a sample. The microscope system includes a light source configured for generating a light beam and an objective configured for receiving the generated light beam and imaging the light beam within the sample. The objective also is configured for imaging light received from the sample in response to the light beam imaged within the sample. A wavefront modulating element is configured for modifying a wavefront of the light received from the sample to reduce aberrations of light emitted from the sample. A detector is configured for receiving the imaged light received from the sample, where the imaged light is imaged onto the detector, and the detector is configured for generating images of the sample based on the light imaged onto the detector. A processor is configured to control the system to introduce one or more known aberrations into at least one image of the sample. The processor is further configured to, based on at least two generated images of the sample, where the generated images include a raw image and at least one image that includes a known aberration, estimate an aberration of a wavefront of light emitted from the sample. The processor is configured to control the wavefront modulating element to modulate the wavefront of light emitted from the sample, such that the estimated aberration of the wavefront of light emitted from the sample is reduced.

Implementations can include one or more of the following features, alone or in any combination with each other.

For example, the wavefront modulating element can include a deformable mirror.

In another example, controlling the system to introduce the one or more known aberrations can include controlling the wavefront modulating element to introduce the one or more known aberrations.

In another example, the wavefront modulating element can include a deformable mirror having multiple electro-mechanical actuators, each actuator being configured to locally deform a portion of a surface of the deformable mirror, and controlling the system to introduce the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include applying a trained machine learning model to the determined phase aberration to determine the voltages.

In another example, the one or more known aberrations can include one or more Zernike modes.

In another example, controlling the wavefront modulating element to modulate the wavefront of light emitted from the sample, such that the estimated aberration of the wavefront of light emitted from the sample is reduced, can include applying a phase correction to the wavefront modulating element, the phase correction being generated from a linear combination of one or more Zernike modes.

In some aspects, the techniques described herein relate to a microscope system for imaging a sample, where the microscope system includes a light source configured for generating a light beam, an objective configured for receiving the generated light beam and imaging the light beam within the sample and for imaging light received from the sample in response to the light beam imaged within the sample, and a detector configured for receiving the imaged light received from the sample, the imaged light is imaged onto the detector, the detector being configured for generating images of the sample based on the light imaged onto the detector. The microscope system can further include a processor configured to: control the system to introduce one or more known aberrations into at least one image of the sample; based on at least two generated images of the sample, where generated images include a raw image and at least one image that includes a known aberration, estimate an aberration of a wavefront of light emitted from the sample; reduce an aberration in the raw image based on the estimated aberration.

Implementations can include one or more of the following features, alone or in any combination with each other.

For example, controlling the system to introduce the one or more known aberrations can include controlling a focus of the objective in the sample to introduce the one or more known aberrations.

In another example, the one or more known aberrations can include one or more Zernike modes.

In some aspects, the techniques described herein relate to a microscope system for imaging a sample, the microscope system including: a light source configured for generating a light beam; an objective configured for receiving the generated light beam and imaging the light beam within the sample and for imaging light received from the sample in response to the light beam imaged within the sample; a wavefront modulating element configured for modifying a wavefront of the light received from the sample to reduce aberrations of light emitted from the sample; a detector configured for receiving the imaged light received from the sample, where the imaged light is imaged onto the detector, and the detector is configured for generating images of the sample based on the light imaged onto the detector. The microscope system can further include a processor configured to: control the system to introduce one or more known aberrations into at least one image of the sample; based on at least two generated images of the sample, the generated images including a raw image and at one least image including a known aberration, estimate an aberration of a wavefront of light emitted from the sample; and reduce an aberration in the raw image based on the estimated aberration.

Implementations can include one or more of the following features, alone or in any combination with each other.

For example, the wavefront modulating element can include a deformable mirror.

In another example, the one or more known aberrations can include one or more Zernike modes.

In another example, the wavefront modulating element can include a deformable mirror having multiple electro-mechanical actuators, each actuator being configured to locally deform a portion of a surface of the deformable mirror, and where controlling the system to introduce the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the electro-mechanical actuator, and where mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the electro-mechanical actuator, and where mapping the determined phase aberration to voltages to apply to the multiple electro-mechanical actuators can include applying a trained machine learning model to the determined phase aberration to determine the voltages.

In another example, the one or more known aberrations can include one or more phase aberrations.

In another example, the processor can be further configured to train a machine learning model to estimate an object in the sample based on the at least two generated images of the sample, and to generate an image of the object based on evaluating the trained machine learning model at spatial coordinates.

In another example, the processor can be further configured to: train a first machine learning model to estimate an actual aberration introduced into the at least one image of the sample in response to the control of the system by the processor, apply the first trained machine learning model to the voltages applied to the actuators for the at least one image to generate an estimated actual aberration introduced into the at least one image of the sample, train a second machine learning model to estimate an object of the sample based on the at least two generated images of the sample and based on the estimated actual aberration, and evaluate the second trained machine learning model at spatial coordinates to generate an image of the object.

In some aspects, the techniques described herein relate to a microscope system for imaging a sample, the microscope system including: a light source configured for generating a light beam; a first wavefront modulating element configured for modifying a wavefront of the generated light beam; an objective configured for receiving the modified wavefront of the generated light beam and for focusing the modified wavefront of the generated light beam within the sample and for imaging light received from the sample in response to the light beam focused within the sample; and a detector configured for receiving the imaged light received from the sample, where the imaged light is imaged onto the detector, the detector being configured for generating images of the sample based on the light imaged onto the detector. The microscope system can further include a processor configured to: control the system to introduce one or more known aberrations into at least one image of the sample; based on at least two generated images of the sample, where the generated images include a raw image and at least one image that includes a known aberration, estimate an aberration of a wavefront of light focused within the sample; and control the first wavefront modulating element to modulate the wavefront of light focused within the sample, such that the estimated aberration of the wavefront of light focused within the sample is reduced.

Implementations can include one or more of the following features, alone or in any combination with each other.

For example, the first wavefront modulating element can include a deformable mirror.

In another example, the first wavefront modulating element can include a spatial light modulator.

In another example, controlling the system to introduce the one or more known aberrations can include controlling the first wavefront modulating element to introduce the one or more known aberrations.

In another example, the first wavefront modulating element can include a deformable mirror having multiple electro-mechanical actuators, each actuator being configured to locally deform a portion of a surface of the deformable mirror, and controlling the system to introduce the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include applying a trained machine learning model to the determined phase aberration to determine the voltages.

In another example, the one or more known aberrations can include one or more Zernike modes.

In another example, controlling the first wavefront modulating element to modulate the wavefront of light emitted from the sample, such that the estimated aberration of the wavefront of light emitted from the sample is reduced, can include applying a phase correction to the first wavefront modulating element, the phase correction being generated from a linear combination of one or more Zernike modes.

In another example, the microscope system can further include: a second wavefront modulating element configured for modifying a wavefront of the light received from the sample, where the processor can be further configured to: control the second wavefront modulating element to modulate the wavefront of light received from the sample, such that the estimated aberration of the wavefront of light received from the sample is reduced.

In another example, the first and second wavefront modulating elements can be the same wavefront modulating element.

In some aspects, the techniques described herein relate to a microscope system for imaging a sample, the microscope system including: a light source configured for generating a light beam; a wavefront modulating element configured for modifying a wavefront of the generated light beam; an objective configured for receiving the modified wavefront of the generated light beam and focusing the modified wavefront of the generated light beam within the sample and for imaging light received from the sample in response to the light beam focused within the sample; a detector configured for receiving the imaged light received from the sample, where the imaged light is imaged onto the detector, the detector being configured for generating images of the sample based on the light imaged onto the detector. The microscope system can further include a processor configured to: control the system to introduce one or more known aberrations into at least one image of the sample; based on at least two generated images of the sample, the generated images including a raw image and at least one image including a known aberration, estimate an aberration of a wavefront of light emitted from the sample; and reduce an aberration in the raw image based on the estimated aberration.

Implementations can include one or more of the following features, alone or in any combination with each other.

For example, the wavefront modulating element can include a deformable mirror.

In another example, the one or more known aberrations can include one or more Zernike modes.

In another example, the wavefront modulating element can include a deformable mirror having multiple electro-mechanical actuators, each actuator being configured to locally deform a portion of a surface of the deformable mirror, and controlling the system to introduce the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the electro-mechanical actuator, and mapping the determined phase aberration to voltages to apply to the multiple electro-mechanical actuators can include applying a trained machine learning model to the determined phase aberration to determine the voltages.

In another example, the processor can be further configured to train a machine learning model to estimate an object of the sample based on the at least two generated images of the sample, and to generate an image of the object based on evaluating the trained machine learning model at spatial coordinates.

In another example, the processor can be further configured to: train a first machine learning model to estimate an actual aberration introduced into the at least one image of the sample in response to the control of the system by the processor, apply the first trained machine learning model to the voltages applied to the actuators for the at least one image to generate an estimated actual aberration introduced into the at least one image of the sample, train a second machine learning model to estimate an object of the sample based on the at least two generated images of the sample and based on the estimated actual aberration, and evaluate the second trained machine learning model at spatial coordinates to generate an image of the object.

In some aspects, the techniques described herein relate to a method for imaging a sample. The method includes providing light to the sample and imaging a wavefront of light received from the sample onto a detector to generate a first image, where the imaged light is received from the sample in response to the provided light. The method further includes modifying, with a wavefront modulating element, the wavefront of the imaged light with one or more known aberrations. The method further includes imaging the modified wavefronts of the imaged light onto the detector to generate one or more phase diversity images, each phase diversity image being associated with a different one of the one or more known aberrations. The method further includes, based on the first image and the one or more phase diversity images, estimating an aberration of a wavefront of the light imaged onto the detector to generate the first image. The method further includes controlling the wavefront modulating element to modulate the wavefront of light received from the sample, such that the estimated aberration of the wavefront of light is reduced when the wavefront is imaged onto the detector.

Implementations can include one or more of the following features, alone or in any combination with each other.

For example, the wavefront modulating element can include a deformable mirror.

In another example, the wavefront modulating element can include a deformable mirror having multiple electro-mechanical actuators, each actuator being configured to locally deform a portion of a surface of the deformable mirror, and modifying the wavefront of the imaged light with the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the multiple electro-mechanical actuators, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the multiple electro-mechanical actuators, and mapping the determined phase aberration to voltages to apply to the multiple electro-mechanical actuators can include applying a trained machine learning model to the determined phase aberration to determine the voltages.

In another example, the one or more known aberrations can include one or more Zernike modes.

In another example, controlling the wavefront modulating element to modulate the wavefront of light received from the sample, such that the estimated aberration of the wavefront of light is reduced when the wavefront is imaged onto the detector, can include applying a phase correction to the wavefront modulating element, the phase correction being generated from a linear combination of one or more Zernike modes.

In some aspects, the techniques described herein relate to a method of imaging a sample, where the method includes providing light to the sample and imaging a wavefront of light received from the sample onto a detector to generate a first image, where the imaged light is received from the sample in response to the provided light. The method further includes modifying, with a wavefront modulating element, the wavefront of the imaged light with one or more known aberrations. The method further includes imaging the modified wavefronts of the imaged light onto the detector to generate one or more phase diversity images, each phase diversity image associated with a different one of the one or more known aberrations. The method further includes based on the first image and the one or more phase diversity images, estimating an aberration of a wavefront of light emitted from the sample. The method further includes reducing an aberration in the first image based on the estimated aberration.

Implementations can include one or more of the following features, alone or in any combination with each other.

For example, the wavefront modulating element can include a deformable mirror.

In another example, the one or more known aberrations can include one or more Zernike modes.

In another example, the wavefront modulating element can include a deformable mirror having multiple electro-mechanical actuators, each actuator being configured to locally deform a portion of a surface of the deformable mirror, and where modifying the wavefront of the imaged light with the one or more known aberrations can include determining a phase aberration to introduce through the deformable mirror and mapping the determined phase aberration to voltages to apply to the multiple electro-mechanical actuators of the deformable mirror to produce the determined phase aberration.

In another example, each of the multiple electro-mechanical actuators can be associated with an influence function characterizing its effect on a reflective surface of the mirror as a function of a voltage applied to the multiple electro-mechanical actuator, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the multiple electro-mechanical actuators, and mapping the determined phase aberration to voltages to apply to the multiple electro-mechanical actuators can include applying a trained machine learning model to the determined phase aberration to determine the voltages.

In another example, the one or more known aberrations can include one or more phase aberrations.

In another example, the method can further include training a machine learning model to estimate an object in the sample based on the first image and generating an image of the object based on evaluating the trained machine learning model at spatial coordinates.

In another example, the method can further include training a first machine learning model to estimate an actual aberration of the one or more phase diversity images, applying the first trained machine learning model to the one or more phase diversity images to generate estimated actual aberrations of the one or more phase diversity images, training a second machine learning model to estimate an object of the sample based on the first image and based on the estimated actual aberrations of the one or more phase diversity images, and evaluating the second trained machine learning model at spatial coordinates to generate an image of the object.

In some aspects, the techniques described herein relate to a method that includes providing light having a first wavefront, and modifying, with a wavefront modulating element, the first wavefront of the provided light with one or more known aberrations to generate one or more modified wavefronts. The method further includes focusing the first wavefront and the one or more modified wavefronts of the provided light within the sample. The method further includes generating a plurality of images of the sample based on light received from the sample in response to the first wavefront of light and the one or more modified wavefronts of light that are focused within the sample. The method further includes based on the plurality of images, estimating an aberration of the first wavefront of light that is focused within the sample. The method further includes controlling the wavefront modulating element to modulate the first wavefront of light, such that an aberration of the wavefront of light that is focused within the sample is reduced.

Implementations can include one or more of the following features, alone or in any combination with each other.

For example, the first wavefront modulating element can include a deformable mirror. In another example, the first wavefront modulating element can include a spatial light modulator.

In another example, the first wavefront modulating element can include a deformable mirror having multiple electro-mechanical actuators, each actuator being configured to locally deform a portion of a surface of the deformable mirror, and modifying, with a wavefront modulating element, the first wavefront of the provided light with one or more known aberrations to generate one or more modified wavefronts can include determining phase aberrations to introduce through the deformable mirror and mapping the determined phase aberrations to voltages to apply to the multiple electro-mechanical actuators of the deformable mirror to produce the determined phase aberrations.

In another example, each of the multiple electro-mechanical actuators can be associated with an influence function characterizing its effect on a reflective surface of the mirror as a function of a voltage applied to the multiple electro-mechanical actuators, and mapping the determined phase aberration to voltages to apply to the multiple electro-mechanical actuators can include determining the voltages based on a linear combination of influence functions of the multiple electro-mechanical actuators.

In another example, each of the multiple electro-mechanical actuators can be associated with an influence function characterizing its effect on a reflective surface of the mirror as a function of a voltage applied to the multiple electro-mechanical actuators, and mapping the determined phase aberration to voltages to apply to the multiple electro-mechanical actuators can include applying a trained machine learning model to the determined phase aberration to determine the voltages.

In another example, the one or more known aberrations can include one or more Zernike modes.

In another example, controlling the wavefront modulating element to modulate the first wavefront of light, such that an aberration of the wavefront of light that is focused within the sample is reduced, can include applying a phase correction to the first wavefront modulating element, the phase correction being generated from a linear combination of one or more Zernike modes.

In another example, the method can further include controlling a second wavefront modulating element to modulate a wavefront of the light received from the sample, such that an aberration of the wavefront of light received from the sample is reduced.

In another example, the first and second wavefront modulating elements can be the same wavefront modulating element.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a schematic diagram of imaging an ideal fluorescent sample.

FIG. 1B is a schematic diagram of imaging a refractile sample.

FIG. 2 is a schematic diagram of a microscope system for correcting an image of a sample using adaptive optics techniques.

FIG. 3 is a schematic diagram of an example approach to using phase diversity techniques for wavefront sensing in a fluorescence microscope system.

FIG. 4 is a schematic diagram of a microscope system for performing phase diversity-based adaptive optics correction of images generated by the system.

FIGS. 5A and 5B are schematic illustrations of a process for determining a wavefront aberration of an image and for correcting the wavefront aberration with adaptive optics.

FIG. 6 illustrates 15 known Zernike polynomials.

FIG. 7A is a schematic diagram of an arrangement of a plurality of actuators that can be coupled to a reflective membrane and that each can be moved individually up and down in response to a voltage applied to the actuator to deform the surface of the membrane.

FIG. 7B is an example schematic diagram of a one-dimensional arrangement of a line of actuators, whose vertical positions determine a shape of a membrane coupled to the actuators.

FIG. 7C is an example schematic diagram showing influence functions for each of the 52 actuators of the pattern shown in FIG. 7A.

FIG. 7D includes a graphical representation of voltages applied to the 52 actuators of FIG. 7A and a graphical representation of an overall phase response of a reflective membrane whose distortion is controlled by actuation of the 52 actuators.

FIG. 7E is a schematic diagram of an overall phase response of a reflective membrane whose distortion is controlled by actuation of the 52 actuators that are coupled to the membrane, where the control is based on a neural network mapping of a predetermined phase to the actuators.

FIG. 7F is a schematic diagram showing a process for training a machine learning model that maps arrays of test voltages applied to the actuators of a deformable mirror to a phase responses of the mirror.

FIG. 7G is a schematic diagram showing relationships between an array of input voltages provided to the actuators of a deformable mirror and phase responses from the mirror to the input voltages.

FIG. 8A is a schematic diagram of a process for correcting an aberrated image of an object to remove the aberration.

FIG. 8B shows example images of objects that include 500 nm fluorescent beads with system aberrations corrected, after inducing aberration, and after one cycle of phase diversity-based AO correction using four diversity images.

FIG. 8C is an example illustration of the effect of increasingly strong aberrations.

FIG. 8D is a graph assessing the dependence of the Pearson correlation coefficient (PCC, y axis) on the random assortment of aberrations, ϕ_{Abe}, with the amount the RMS wavefront distortion being indicated on the x-axis.

FIG. 8E is a graph that is similar to FIG. 8D but assessing the wavefront estimation by examining the RMS wavefront distortion in the estimated aberration vs. the test aberration.

FIG. 8F is a graph showing the quality of images resulting from a single correction as a function of the number of diversity phases used in wavefront estimation.

FIG. 8G is a graph showing a quality of correction as a function of the number of correction cycles for aberrations, ϕ_{Abe}, with RMS wavefront distortions of 50 nm, 150 nm, 250 nm, 350 nm, 450 nm using the same data in in FIGS. 8B and 8C.

FIG. 8H is a graph showing the total time and the computational time for performing a first correction iteration as a function of the RMS magnitude of ϕ_{Abe}.

FIG. 9A is a ground truth image of U2OS cells that were fixed and immunostained for microtubules.

FIG. 9B is a distorted image of the U2OS cells in FIG. 9A in which a 219 nm RMS wavefront distortion was added to blur the images to the extent that individual fibers were indiscernible.

FIG. 9C is an AO corrected image the image in FIG. 9B in which PD was used to sense the aberrated wavefront, and the sensed aberrated wavefront was used to dramatically improve image quality of the blurred images with only two correction cycles.

FIG. 9D is an AO corrected image corrected image the image in FIG. 9B similar to the image of FIG. 9C but in which the PD algorithm intentionally neglects to correct the defocus Zernike mode.

FIG. 9E is a ground truth image of U2OS cells that were fixed and immunostained for microtubules.

FIG. 9F is a distorted image of the U2OS cells in FIG. 9E in which a 219 nm RMS wavefront distortion was added to blur the images to the extent that individual fibers were indiscernible.

FIG. 9G is an AO corrected image the image in FIG. 9F in which PD was used to sense the aberrated wavefront, and the sensed aberrated wavefront was used to dramatically improve image quality of the blurred images with only two correction cycles.

FIG. 9H is an AO corrected image corrected image the image in FIG. 9F similar to the image of FIG. 9G but in which the PD algorithm intentionally neglects to correct the defocus Zernike mode.

FIG. 9I is a ground truth image of immunostained myosin in fixed Ptk2 cells captured by a widefield microscope.

FIG. 9J is an aberrated image of the immunostained myosin in fixed Ptk2 cells of the image of FIG. 9I, where the image of FIG. 9I has been aberrated by 311 nm RMS wavefront distortion.

FIG. 9K is an AO corrected image of the image of FIG. 9J, where PD was used to estimate the aberration and a phase map was applied to the deformable mirror to cancel the estimated aberration.

FIG. 9L is a graph showing a line profile comparison along the green line (i), the red line (ii), and the magenta line (iii) in FIGS. 9I, 9J, and 9K, respectively, showing that AO correction recovers peak profiles that are absent in the aberrated image.

FIG. 9M is a view of the portion of the image in FIG. 9I, which portion is shown by the dashed rectangle in FIG. 9I.

FIG. 9N is detailed view of the portion of the image in FIG. 9J, which portion is shown by the dashed rectangle in FIG. 9J.

FIG. 9O is a detailed view of the portion of the image in FIG. 9K, which portion is shown by the dashed rectangle in FIG. 9K.

FIG. 9P is a detailed view of the portion of the image in FIG. 9M, which portion is shown by the solid rectangle in FIG. 9M.

FIG. 9Q is a detailed view of the portion of the image in FIG. 9N, which portion is shown by the solid rectangle in FIG. 9N.

FIG. 9R is a detailed view of the portion of the image in FIG. 9O, which portion is shown by the solid rectangle in FIG. 9O.

FIG. 10 is a schematic diagram illustrating the effect of multiple iterations of sensing with phase diversity to estimate an aberration of a wavefront and then applying an adaptive optics correction with a wavefront modulating element.

FIG. 11 illustrates an example workflow for estimating the wavefront.

FIG. 12 is a schematic diagram illustrating processes for generating images from input data.

FIG. 13A is a schematic depiction of a process for generating an unaberrated image of an object using a trained machine learning model.

FIG. 13B is a schematic depiction of a process for generating a phase map of an aberration present in an image of the object using a machine learning model.

FIG. 14 is a schematic depiction of a process for generating an estimate of an object and an estimate of an aberration with machine learning models.

FIG. 15 is a schematic diagram illustrating different images produced using phase diversity-based adaptive optics techniques, along with the phase aberrations and point spread functions associated with the images.

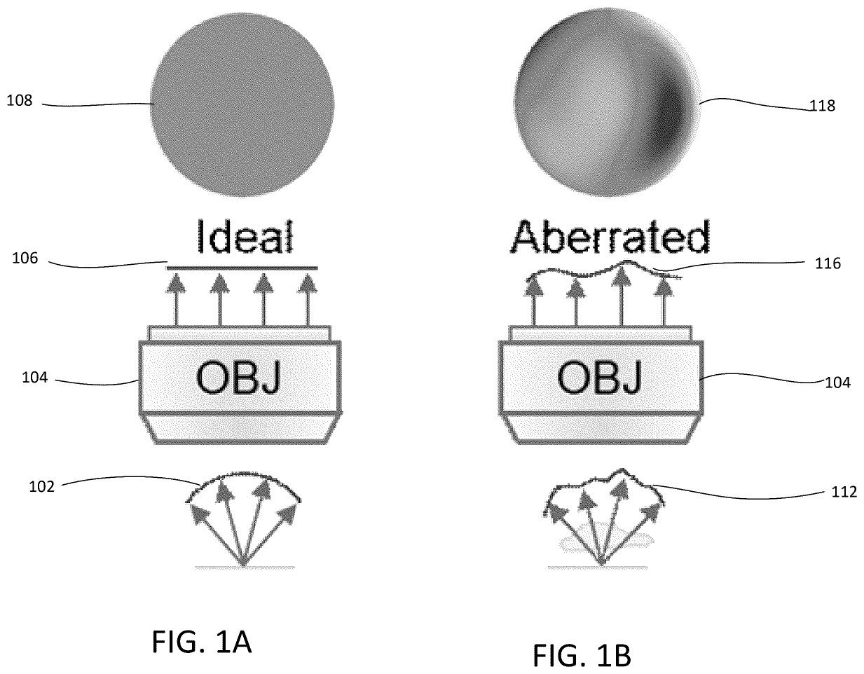

### DETAILED DESCRIPTION

This disclosure relates generally to a rapid, sensitive, and robust wavefront sensing scheme based on phase diversity. The techniques described herein can enable accurate wavefront sensing and aberration correction in a microscope system to less than λ/35 root mean square (RMS) error with few measurements and can enable the use of adaptive optics to correct aberrations with no additional hardware added to the microscope system besides a corrective element.

In samples thicker than a single cell, the presence of optical aberrations hinders diffraction-limited imaging. Adaptive optics technologies (AO) attempt to restore imaging performance by (i) sensing the distorted wavefront and (ii) applying (typically via an adaptive element such as a deformable mirror or spatial light modulator) a corrective wavefront of equal amplitude but opposite sign, thereby suppressing optical aberrations. AO provides a means of counteracting system- and sample-induced aberrations, yet despite ongoing refinement, AO techniques have not been widely adopted, perhaps because additional hardware must be integrated into the optical path, which is not trivial to set up, and often adds considerable complexity, processing time and cost relative to the base microscope. In addition, existing AO methods require dedicated algorithms and software for wavefront sensing and corrective feedback, which may be difficult to obtain and many AO methods (especially indirect methods) require substantially more measurements (and time) to sense the aberrations than to acquire the aberrated image.

Thus, effective real-time sensing of the distorted wavefront, performed as rapidly and accurately as possible, with low-complexity and low-cost components is desirable, so that AO-corrected images can be generated in real-time (e.g., in a few seconds or less), while a user is using the microscope system to observe a sample through an objective of the system.

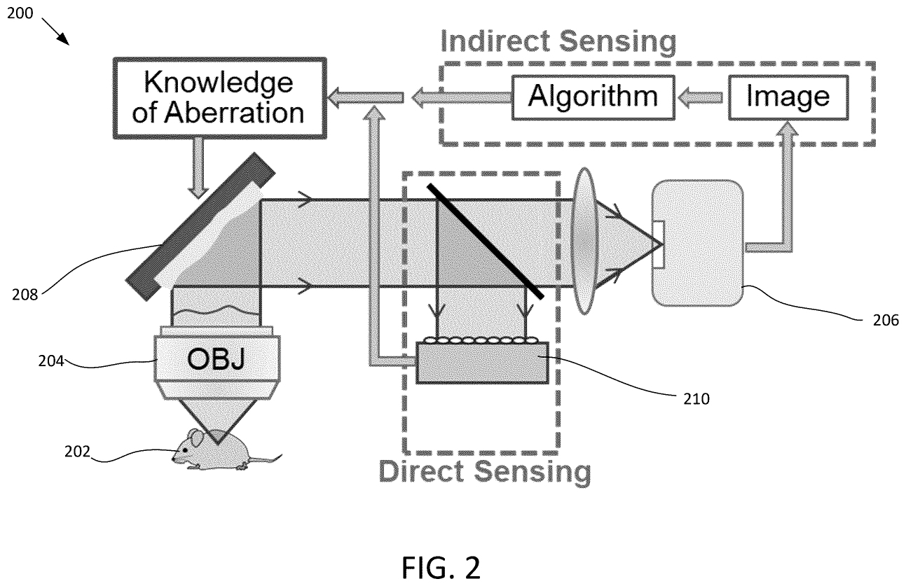

Wavefront sensing methods can be broadly classified as ‘direct’ or ‘indirect’, and both classes have been used effectively for AO in confocal, multiphoton, light sheet, and super-resolution imaging. FIG. 2 is a schematic diagram of a microscope system 200 for correcting an image of a sample 202 using adaptive optics techniques, in which the aberrated wavefront of light from sample 202 captured through an objective 204 is imaged by a detector 206 and knowledge of the aberrated wavefront is used to apply an equal and opposite corrective wavefront using a deformable element 208.

The AO techniques can be broadly divided into two classes based on the method of wavefront sensing. In direct sensing techniques, a dedicated wavefront sensor 210 is used in a separate optical path to sense aberrations of the wavefront. By contrast, indirect sensing techniques use the same optical path to sense aberrations of the wavefront and for fluorescence imaging of the sample and employ algorithms to sense the wavefront based on fluorescent images of the sample.

Direct sensing approaches use dedicated hardware (often a Shack-Hartmann wavefront sensor, SHWFS) to rapidly sense the wavefront, and are most effective in conjunction with point-like sources (e.g., “guide stars”) that must be introduced into the sample exogenously or optically. Typical disadvantages of direct approaches include: the need to form an image on the wavefront sensor (which requires sufficient ballistic signal to reach the sensor); that these approaches generally are limited to weakly scattering samples; the cost of the sensing hardware; the low sensitivity of the sensing hardware; and the possibility of different aberrations in the sensing vs. imaging paths.

By contrast, indirect sensing methods reconstruct the wavefront from a sequence of intensities or images, each with a corresponding change applied to the adaptive element. Advantages of indirect approaches include their relatively low cost and simple hardware (since no dedicated wavefront sensor, such as a SHWFS, is needed for sensing the aberrated wavefront) and improved performance in opaque tissue (since the requirement for ballistic signal is usually relaxed). Existing approaches to indirect sensing have been relatively slow speed, because they need many sequential measurements of the sample, and the associated computational burden of processing the measurements results in slow wavefront sensing, which often takes far longer than the time required for image acquisition.

As described herein, we present a rapid and accurate implementation of an indirect sensing AO system based on phase diversity (PD) techniques that can efficiently estimate both an extended object and the associated aberrated wavefront from as few as two images, and we demonstrate use of these techniques in wavefront sensing and AO. With the techniques disclosed herein, phase diversity AO correction can be performed with the addition of only an adaptive element and accompanying relay optics, which simplifies microscope design and improves emission-side light efficiency compared to direct sensing approaches. Moreover, in some implementations, phase diversity AO correction can be performed even without an adaptive element but rather by using existing optical elements of a microscope system to provide known diversity aberrations in images, which then can be used to correct unknown aberrations in images collected with the microscope. In addition, with the disclosed phase diversity-based AO techniques, only a few additional images are required to sense the wavefront, so that sensing can occur on sub-second timescales.

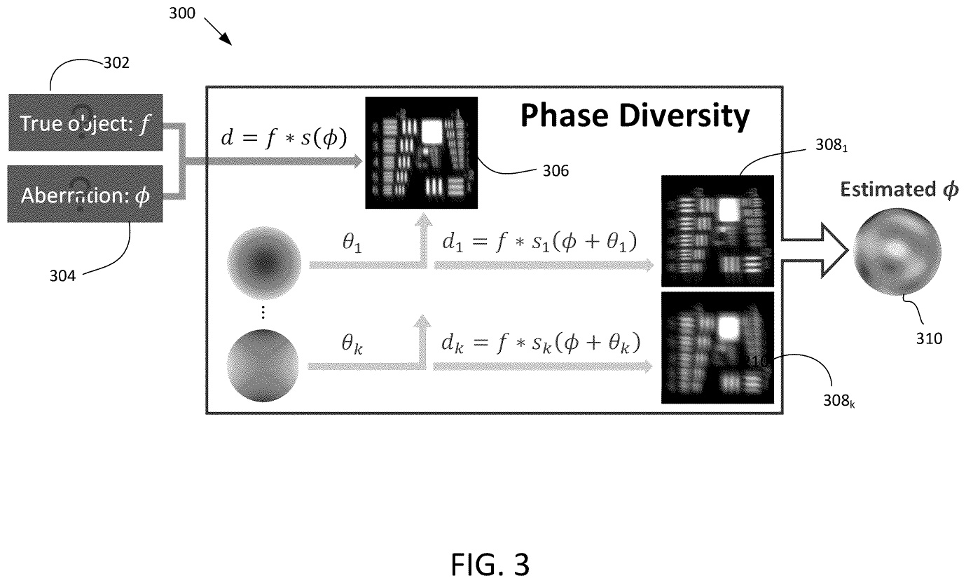

FIG. 3 is a schematic diagram of an example approach to using phase diversity techniques for wavefront sensing in a fluorescence microscope system. Given the unknown true object f (302) that is subject to an aberration (304) having an unknown aberrated point spread function s(ϕ) the image d (306) of the object does not contain sufficient information to infer the unknown aberration. However, in the phase diversity techniques described herein, additional aberrated images d₁, . . . , dₖ (308₁ . . . 308ₖ) are collected, with the additional aberrated image having known diversity aberrations θ₁, . . . , θₖ purposefully added. The set of diversity images d₁, . . . , dₖ thus contribute additional information, enabling the estimation of the unknown aberration ϕ.

In fluorescence imaging, the formation of an image d can be represented as a convolution between the object f and the point spread function s(ϕ), d=f*s(ϕ), where ϕ represents a phase aberration, noise is neglected, and s is assumed to be spatially invariant. For AO applications, it is desirable to estimate ϕ and to compensate for it, thereby improving image quality. In general, f and ϕ are both unknown and thus we cannot estimate either for ϕ from the single image d. Phase diversity methods address this problem through the collection of additional diversity images d₁, . . . , dₖ in which known diversity aberrations θ₁, . . . , θₖ are purposefully introduced physically into the images (e.g., by controlling the imaging system to introduce aberrations into the images. The additional information contained within such images allows us to estimate f and the unknown aberration ϕ, as explained with reference to FIG. 3.

While some applications of phase diversity AO have focused on astronomical applications in which aberrations are caused by random atmospheric turbulence, the techniques described herein are well suited to fluorescence microscopy in which aberrations to be corrected may be more smoothly varying than those caused by atmospheric turbulence. Given the original aberrated image, d, the ideal PSF s, the additional diversity images d₁, . . . , dₖ and the known diversity aberrations ϕ₁, . . . , ϕₖ, our algorithm can use an optimization algorithm (e.g., the Gauss-Newton algorithm) to rapidly estimate both f and ϕ (310). In addition, the techniques disclosed herein can be performed based on the original aberrated image, d, and a small number of additional phase diversity images (e.g., four or fewer, two or fewer, or even just one), which is advantages for use in fluorescence microscopy applications, especially when applied to living samples, where the fluorescing molecules may emit a limited amount of light or photons before they photobleach and where a living sample may move randomly while being imaged. Using a small number of phase diversity images to perform PD-based AO correction allows the correction to be performed very fast, so that the corrections can be applied quickly before the molecules photobleach and before the samples moves appreciably.

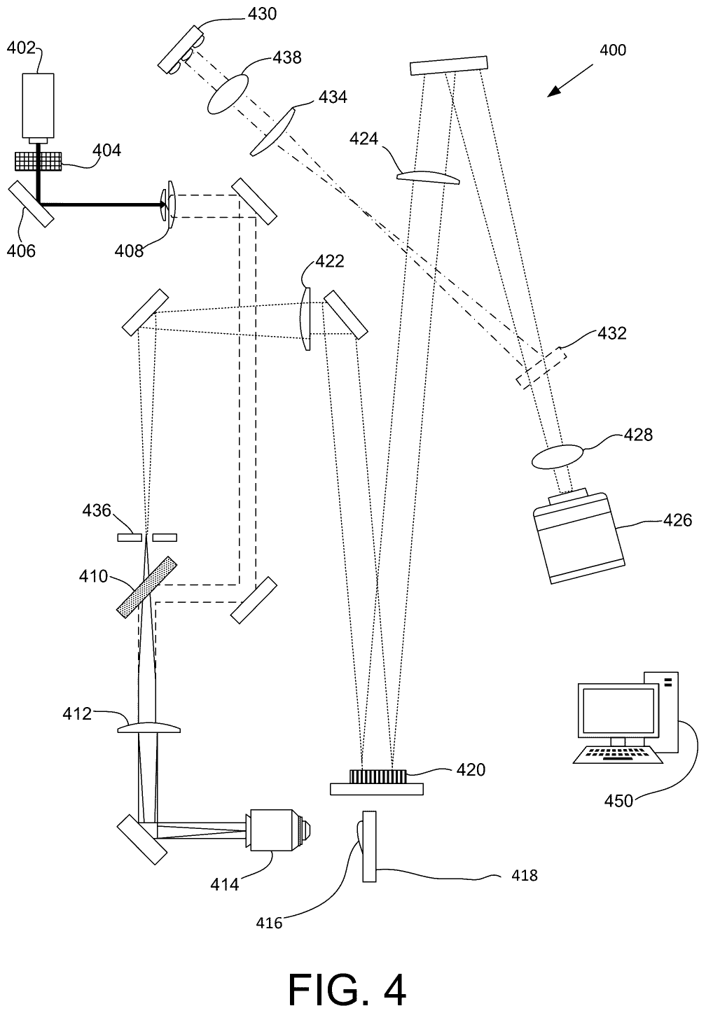

FIG. 4 is a schematic diagram of a microscope system 400 for performing PD-based AO correction of images generated by the system. In some implementations, microscope system 400 can be a widefield fluorescence microscope system, but other microscopy techniques also are possible, such, for example, point scanning microscope system (e.g., a two-photon microscope system), a line scanning microscope system, a light sheet microscope, etc. The system includes a light source 402 (e.g., a laser) that emits light. A shutter 404 can be opened/closed to allow/block light from being transmitted to other components of the system. A mirror 406 sends the light to a beam expander 408, and then the light is reflected by a dichromatic mirror 410 and focused with lens 412 located at the back focal plane of an objective 414 (e.g., a 60×, 1.2 NA water immersion objective). In some implementations, the objective 414 can be held in a movable mount, for example, a rapid automated modular microscope (RAMM) system equipped with a motorized stage (for coarse axial objective positioning and lateral sample positioning) and a piezoelectric stage (for fine axial sample displacement, e.g., 150 micrometer travel). The objective 414 focuses the light onto, or within, an object 416 that is supported on a substrate or stage 418.

Fluorescence light emitted from the object 416 is collected in epi-mode through the same objective 414 and transmitted through the lens 412 and the dichroic mirror 410 to a wavefront modulating element 420. In some implementations, the wavefront modulating element 420 includes a deformable mirror but other wavefront modulating elements also are possible, for example, a spatial light modulator or a spatially-controllable transmissive phase mask. Although the wavefront modulating element 420 generally is referred to as a deformable mirror herein, other wavefront modulating elements also are possible. In some implementations, a second lens 422, for example, placed in 4f relation to the lens 412, can be used to magnify and image the pupil of the objective 414 to fill the diameter of the deformable mirror 420. In some implementations, the fluorescence light from the object 416 can be directed to the deformable mirror 420 at an angle (e.g., 5°) to the normal direction of the surface of the mirror to minimize off-axis aberrations.

After being reflected from the deformable mirror 420, the fluorescence light from the object 416 is focused by a lens 424 (e.g., a 750 mm focal length achromat) placed one focal length away from the deformable mirror to image the sample plane onto a detector 426, for example, an electron multiplying charge coupled device. In an example implementation, the pixel size in image space, Sₚₓ, can be 104 nm, and the illuminated area can span the majority of a (e.g., about 106.5 μm) field of view. A bandpass filter 428 located upstream of the detector 426 can be used to reject pump light from the light source 402 that might propagate past the deformable mirror 420 along the optical path.

In some optional implementations, for example, to compare the performance of the phase diversity-based adaptive optics techniques disclosed herein with traditional techniques based on use of a dedicated wavefront sensor (for example, a Shack-Hartmann wavefront sensor), the microscope system 400 can include a Shack-Hartmann wavefront sensor 430 that can be used to determine a wavefront of the fluorescence light emitted from the object 416. In some implementations, the fluorescence light can be coupled to the wavefront sensor 430 by a flip mirror 432 located downstream from the lens 424 and upstream of the detector 426. A lens 434, for example, 180 mm focal length achromat, can be placed in 4f relation to the lens 424 and can serve to demagnify and relay the image of the objective pupil from the deformable mirror 420 to the Shack-Hartmann sensor 430. When using the Shack-Hartmann wavefront sensor 430, an iris 436 can be placed at the intermediate image plane (e.g., the focal point midway between the lenses 412, 422) to isolate the signal from a single guide star located within the object 416. In some implementations, the guide star can include a 500 nm diameter fluorescent bead. A bandpass emission filter 438 can be located in the optical path in front of the Shack-Hartmann wavefront sensor 430.

Components of the microscope system 400 can be controlled by the one or more computing devices 450 that include one or more processors configured for executing computer readable instructions and one or more memories configured for storing the computer-readable instructions. For example, the computing device 450 can control the light source 402 and the shutter 404 to provide light to the object 416 and can control the deformable mirror 420, such that the deformable mirror alters the phase of different portions of a wavefront of light received from the object 416. The computing device 450 can also control the detector 426 to generate images of the object based on fluorescence light received from the sample and to process one or more images of the object to determine an aberration of an image of the object and to determine a phase correction to be applied to the deformable mirror to reduce or minimize the aberration of the image.

In example implementations, the deformable mirror 420 can be controlled by the computing device 450 and used to introduce known diversity aberrations into the microscope system 400, for example, by controlling the deformable mirror 420 to introduce the aberrations, and a plurality of images of an object 416 can be captured by the detector 426, where the different images include different known diversity aberrations that are applied by the deformable mirror. Although a deformable mirror 420 is shown in the microscope system 400 for introducing the diversity aberrations, other techniques also are possible for introducing diversity aberrations. For example, masks that introduce a known aberration can be inserted into the optical beam path, for example, at a conjugate pupil plane, to introduce the particular aberrations.

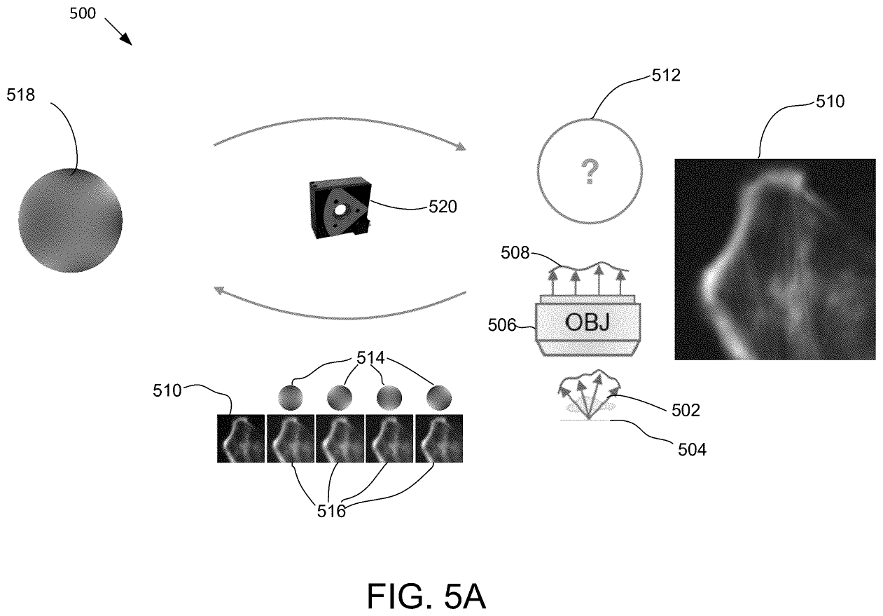

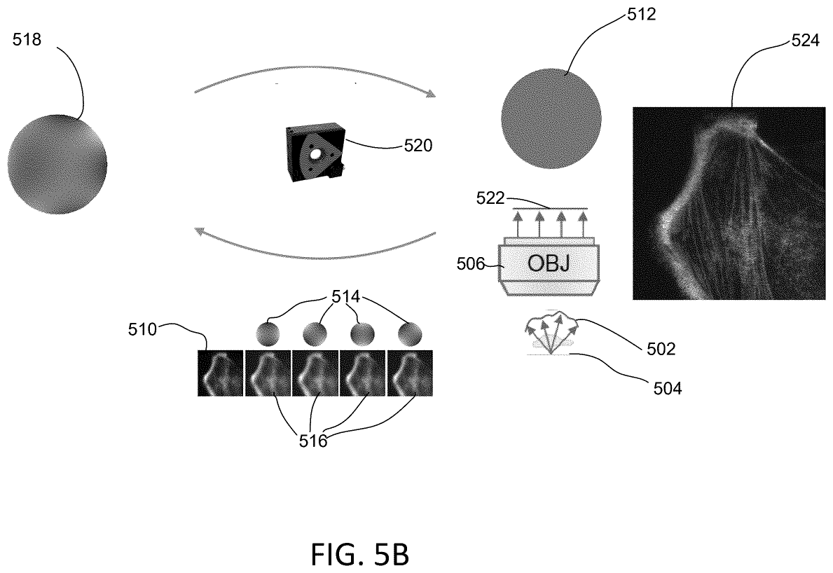

FIGS. 5A and 5B are schematic illustrations of a process for determining a wavefront aberration of an image and for correcting the wavefront aberration with adaptive optics. As shown in FIG. 5A, fluorescence light 502 is collected from a focal plane 504 of an objective 506 (for the focal point can be within an object) and imaged onto a detector to form an image 510 of the object, where the image may be distorted. A wavefront 508 of the fluorescence light from which the image 510 is generated can be aberrated, for example, due to refraction by the material of the object or by components of the optical system, and the aberration 512 of the wavefront may be unknown. A number of known aberrations 514 that are different from each other can be introduced into the optical system, for example, by a deformable mirror 520 in the optical path to produce a number of different aberrations of the wavefront, such that different distorted images 516 are produced as a result of the intentionally-applied aberrations.

Referring to FIG. 5B, the aberrated images 510, 516 can be processed to determine the aberration 518 that distorts the image 510, for example, using techniques described in more detail herein. Then, an inverse of the determined aberration can be applied by the deformable mirror to the wavefront of the fluorescence light to cancel the determined aberration to generate a corrected wavefront 522 in an image 524 of the object that is produced at the detector.

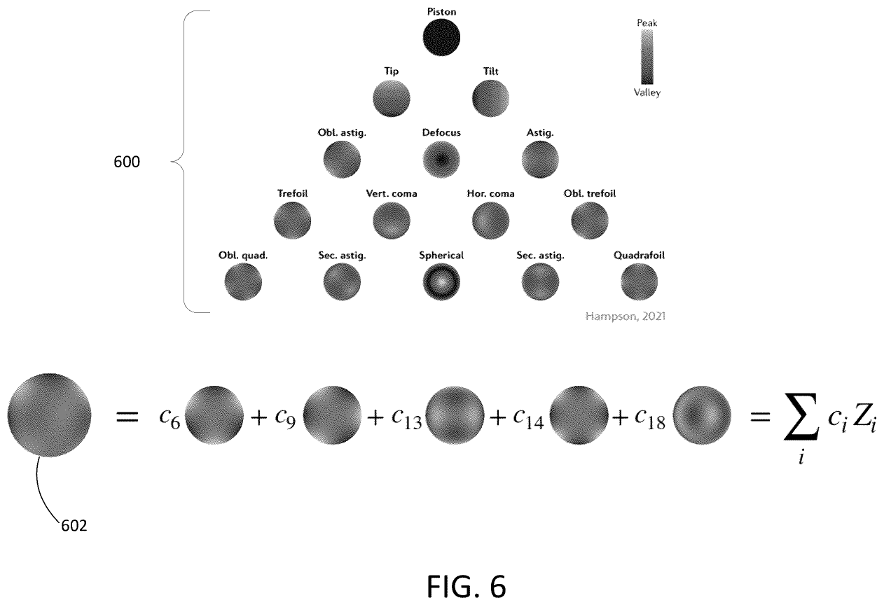

The deformations applied to the deformable mirror to generate the known aberrations can be selected from a plurality of known optical modes. In some implementations, the known aberrations can correspond to Zernike polynomials. FIG. 6 illustrates 15 known Zernike polynomials 600, where the colors in the illustration of each mode indicate a relative phase at a point on the wavefront, that can be applied to the deformable mirror to generate the known aberrations. In an implementation, an arbitrary phase 602 can be represented by, and constructed from, a linear superposition of different Zernike modes.

Simulations were performed to determine the relative efficacy of different types of diversity aberrations, the effect of increasing the number of diversity images, the effect of signal-to-noise ratio (SNR) in the aberrated image, and provided insight for selecting parameters for use in applying phase diversity-based AO to correct aberrated images. For example, different types of diversity aberrations, which can be based on the Zernike modes of FIG. 6, can include defocusing an objective lens, introducing an astigmatism into the optical system, introducing a spherical aberration into the optical system, and defocusing the sample. In all cases, the diversity aberration is caused by intentionally introducing a known imperfection into the optical system that is used to image the object or that is used to provide illumination light to the object.

Aberrations based on astigmatism, primary spherical, and defocus Zernike basis functions were relatively effective as diversity aberrations for determining the aberration of a raw image, but coma and trefoil were relatively ineffective. Using more diversity images provided better aberration estimation than using fewer images, although for the diversity phases we chose, performance gains saturated at four diversities (for a total of five images, including the initial aberrated image). Finally, the quality of wavefront sensing deteriorated at lower input image SNR, although the algorithm provided usable wavefront estimation for input root-mean-square (RMS) wavefront distortions up to ˜0.25 μm even with input image SNR as low as ˜3.

Referring again to FIG. 4, the deformable mirror 420 is used to introduce known aberrations in the optical path to generate a set of phase diversity images and used to apply an AO correction to an aberrated wavefront of an image of an object. To accomplish this, the deformable mirror 420 can include a plurality of electromagnetic actuators (for example, arranged in a grid pattern), with each actuator being configured to deform the shape of a reflective membrane coupled to the plurality of actuators in a location associated with the actuator, thereby deforming the shape of the reflective membrane. In this manner, a wavefront of light reflected from the membrane provides localized phase distortions across the wavefront, which can introduce or correct aberrations in the wavefront.

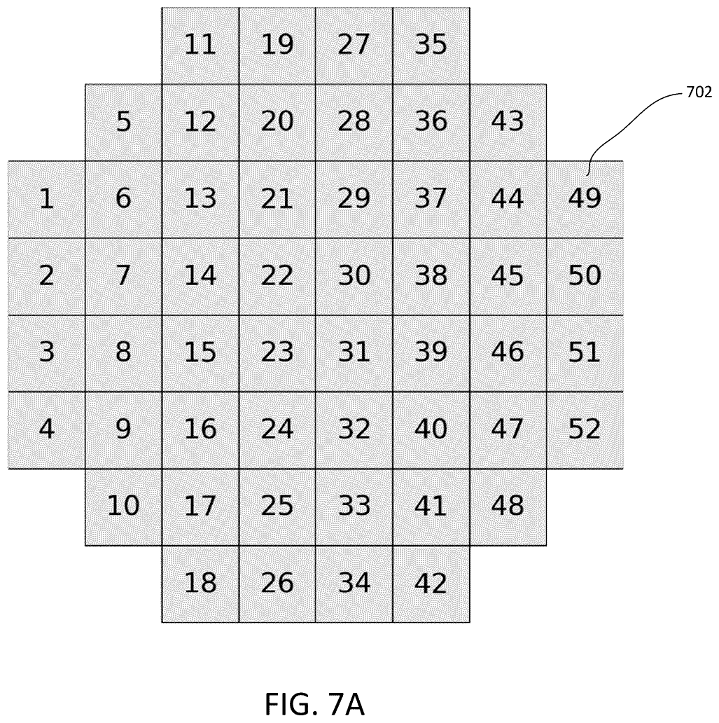

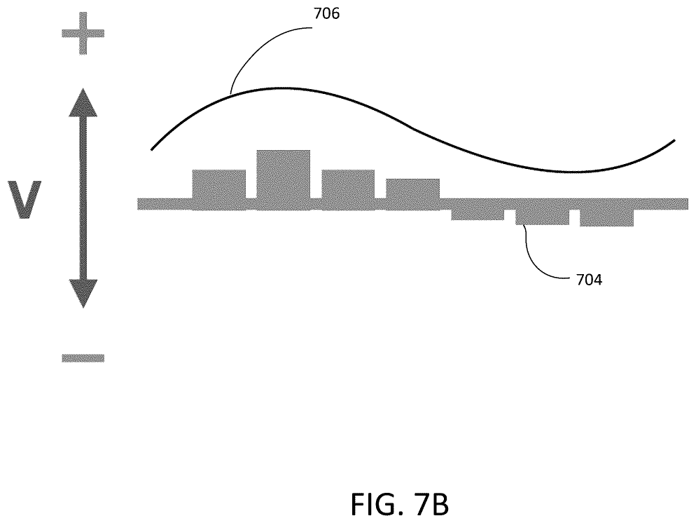

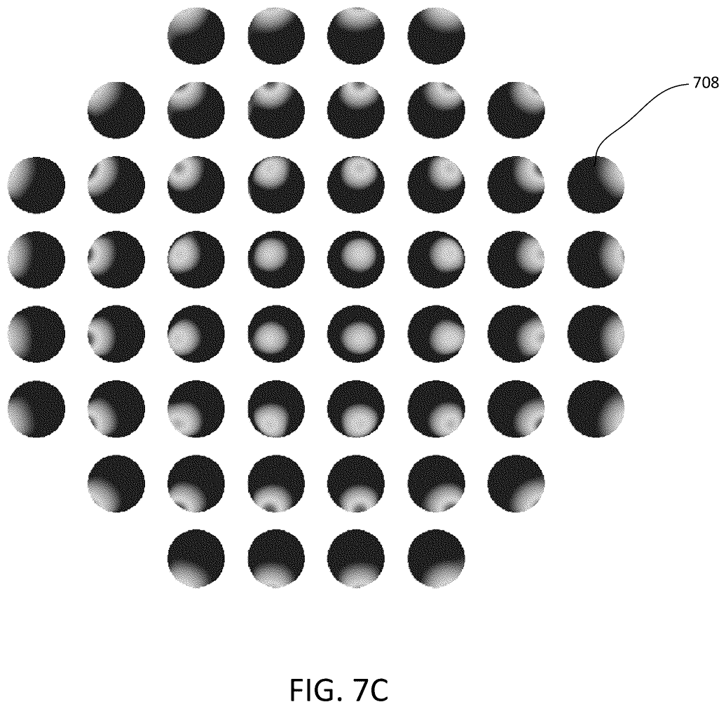

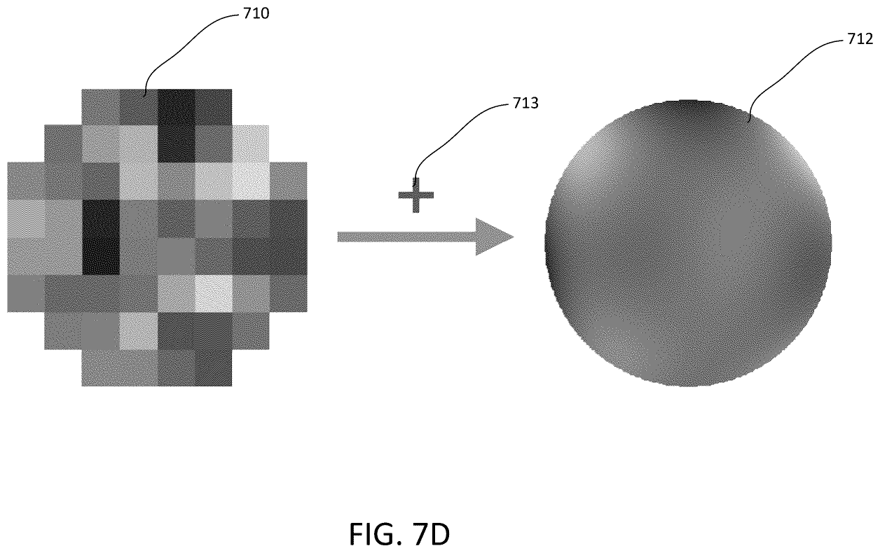

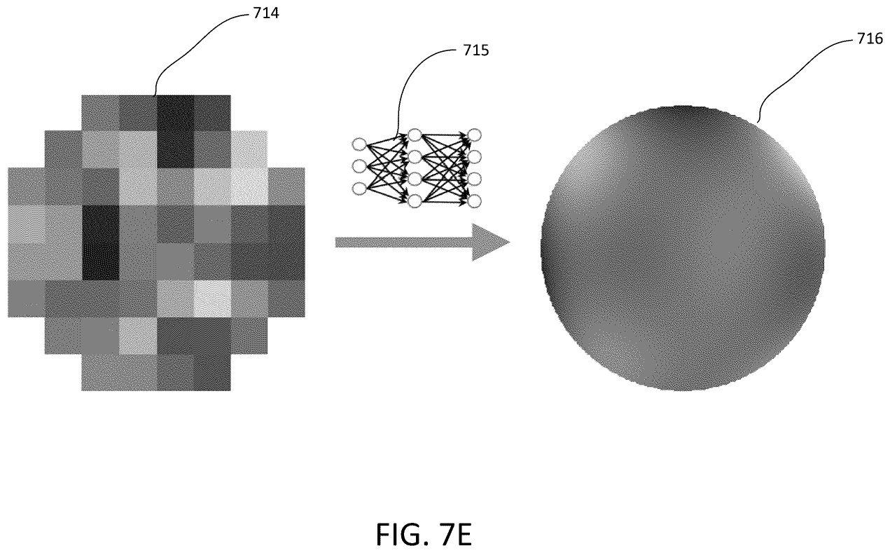

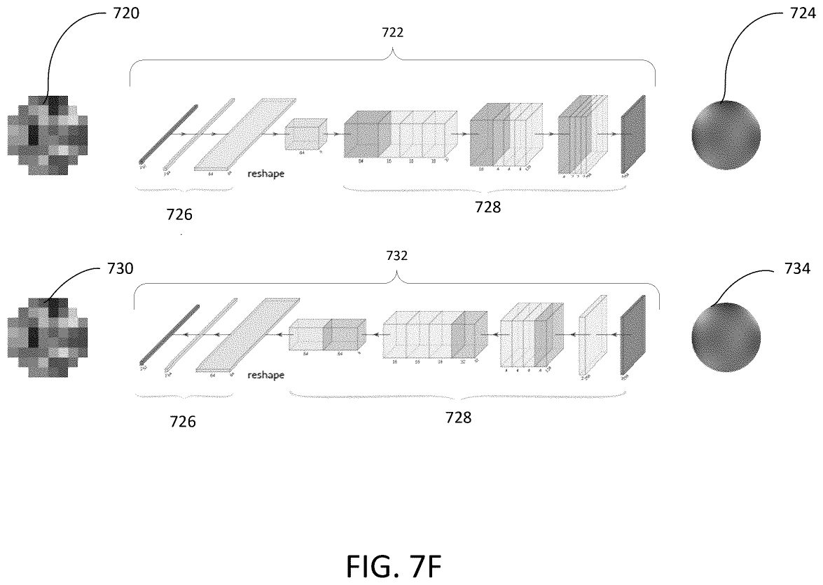

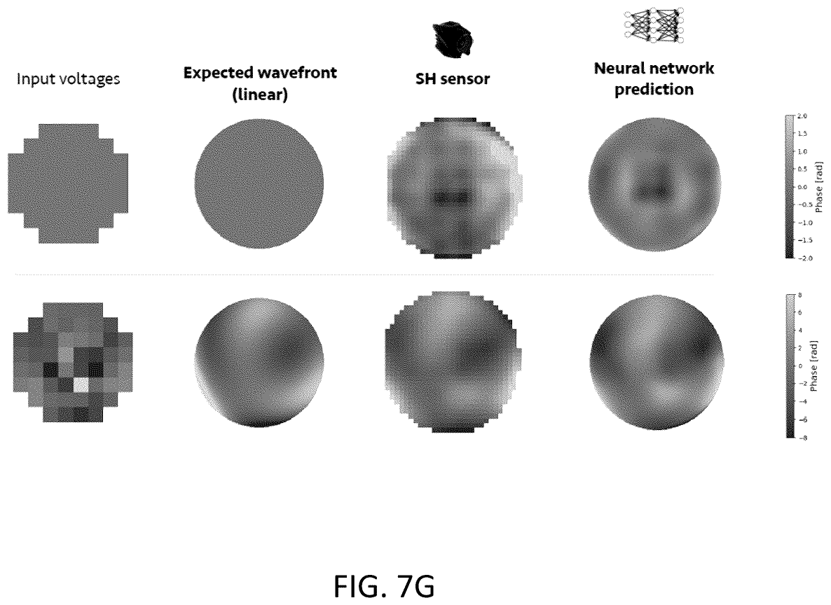

FIG. 7A is a schematic diagram of an arrangement of a plurality of 52 actuators 702 that can be coupled to a reflective membrane and that each can be moved individually up and down (i.e., out of and into the page in FIG. 7A), in response to a voltage applied to the actuator to deform the surface of the membrane. Each actuator is labelled numerically in FIG. 7A. FIG. 7B is an example schematic diagram of a one-dimensional arrangement of a line of actuators 704, whose vertical positions determine a shape of a membrane 706 coupled to the actuators.

Applying a desired phase change to the wavefront with the deformable mirror relies on accurate calibration of each actuator, so that the voltages applied to each actuator to introduce a phase change can be accurately mapped to a resulting phase change. Calibration in this context means determining an ‘influence function’ of each actuator (the induced wavefront as a function of applied voltage), where the influence function characterizes the phase change induced by the deformable mirror as a function of the voltage applied to the actuator. Once known, the influence functions can be inverted, thereby generating a ‘control matrix’ that provides the per-actuator voltage needed for a desired aberration.

FIG. 7C is an example schematic diagram showing influence functions 708 for each of the 52 actuators of the pattern shown in FIG. 7A, with each influence function in the arrangement of FIG. 7C corresponding to the actuator that is in the same location within the arrangement of FIG. 7A. The 52 individual influence functions of FIG. 7C represent the effect of the individual actuators of FIG. 7A on the reflective membrane, where the individual influence functions represent the distortion over the entire reflective membrane caused by moving the actuator by a particular amount, with the colors of the influence functions representing the amount of distortion over the reflective membrane.

FIG. 7D is a schematic diagram showing how different voltages applied to different actuators of the arrangement in FIG. 7A affect the phase imparted by the mirror over the surface of the mirror. FIG. 7D includes a graphical representation 710 of the voltages applied to the 52 actuators, in which the different colors correspond to different voltages, and therefore different displacements of the actuators, and a graphical representation 712 of an overall phase response of a reflective membrane whose distortion is controlled by actuation of the 52 actuators that are coupled to the membrane, in which the different colors correspond to different phase. When different voltages are applied to different actuators, as shown in representation 710, with the assumption that the influence functions of the different actuators can be linearly combined, the resulting overall phase response of the reflective membrane can be estimated, as shown in representation 712.

Because calibration of the mirror relies on accurate wavefront sensing, calibration of the mirror provides an excellent initial test of the phase diversity techniques disclosed herein. To perform such a test, referring again to FIG. 4, we began by obtaining a benchmark calibration using a gold standard of a commercially available Shack-Hartmann wavefront sensor 430. We applied positive and negative voltages to each actuator of the deformable mirror 420, at each voltage imaging the associated fluorescence from a single 500 nm bead (the ‘guide star’) in the object 416 onto the SHWFS. We then converted the measured SHWFS images into wavefronts by using the manufacturer's software, then determined the linear relationship between wavefront and voltage, producing the influence functions for each actuator. We empirically determined the illumination power and exposure time necessary to produce high quality wavefronts, finding that with these settings we could reliably calibrate the mirror in 118 seconds using the SHWFS (115 seconds for acquisition and 3 seconds for processing).

The PD techniques described herein do not require an independent wavefront sensor but rather make use of known diversity aberrations to sense an unknown wavefront. Because our microscope also incorporated a piezoelectric stage 418, we reasoned that stage defocus could readily provide such known diversities and that stage defocus is an especially convenient choice as it does not rely on a calibrated mirror. For each actuator, we applied the same voltages as for the SHWFS calibration, but also applied different stage defocuses (±2 μm, ±1 μm, 0 μm) at each voltage and captured the associated images with the detector 426. Feeding each set of five images into our PD algorithm produced a unique wavefront for each voltage (as explained in more detail below) subsequently enabling us to determine the induced wavefront as a function of voltage on the actuator (i.e., the influence function of the actuator). Unlike an approach that uses a SHWFS, PD-based techniques cannot directly estimate tip/tilt components in the wavefront. We thus developed an indirect method for estimating the contribution of these Zernike modes, relying on PD's ability to estimate the object (and thus, the tip/tilt-induced displacement of the object at each voltage (as explained in more detail below), and the tip/tilt corrected influence functions closely resembled the SHWFS ground truth.

Even though the PD-derived influence functions required ten measurements per actuator instead of only two, we found that the greater sensitivity of the detector 426 as compared with the Shack-Hartmann wavefront sensor 430 permitted the acquisition of each image in only 30 ms, and with ˜3-fold less power than when using the SHWFS. Thus, including both the shorter acquisition time (53 s) and computation time (13 s), the total time for calibrating all actuators was only 66 s, which is faster than a typical calibration of the SHWFS.

Referring again to FIG. 7D, the mapping between individual actuator voltages and the resulting phase response of the deformable mirror is based on an assumption that the influence functions for each actuator are linearly combined to map the array of voltages to the overall phase response of the mirror, where the linear combination is represented by the “+” sign 713 in FIG. 7D. However, a nonlinear mapping between the individual actuator voltages of the deformable mirror and the phase response of the mirror can be achieved by using a trained machine learning model to map the actuator voltages to the phase response.

FIG. 7E is a schematic diagram showing how different voltages applied to different actuators of the arrangement in FIG. 7A affect the phase imparted by the mirror over the surface of the mirror. FIG. 7E includes a graphical representation 714 of the voltages applied to the 52 actuators, in which the different colors correspond to different voltages, and therefore different displacements of the actuators, and a graphical representation 716 of an overall phase response of a reflective membrane whose distortion is controlled by actuation of the 52 actuators that are coupled to the membrane, in which the different colors correspond to different phase. The different voltages that are applied to different actuators, as shown in representation 714, can be mapped to the resulting overall estimated phase response of the reflective membrane, as shown in representation 716 though a trained machine learning model 715, where the model need not be based on linear combinations of the influence functions of individual actuators. Similarly, a machine learning model can be trained to map a predetermined phase response of the reflective membrane to individual voltages to be applied to the actuators of the deformable mirror to achieve the predetermined phase response.

FIG. 7F is a schematic diagram showing a process for training two machine learning models 722 and 732. The first model 722 is trained to map voltages 720 applied to the actuators of a deformable mirror to the phase response 724 of the mirror. The second model 732 is trained to map a desired phase response 734 of the mirror to the required voltages 730 applied to the actuators of a deformable mirror. Training data used for training the machine learning models 722 and 732 can include hundreds or thousands of randomly selected combinations of input voltages that are applied to the 52 actuators of the deformable mirror and phase responses of the deformable mirror that are measured in response to each of the combinations. For example, the models can be trained based on images generated from the sample that include fluorescent beads. Hundreds or thousands of images of the sample can be generated when different randomly selected combinations of input voltages are applied to the actuators of the deformable mirror for each image, and the measured wavefronts of the images. This data can be used for training and testing of the models.

The architecture of the machine learning model that maps the input voltage applied to the deformable mirror to the phase response of the mirror can be comprised of a number of fully connected layers 726 and a number of convolutional layers 728 with non-linear activation functions. Pairs of voltage array values and resulting phase responses can be input as training data to the network, and model parameters can be adjusted to minimize an error between predicted phase responses and actual phase responses. The models 722, 732 can be validated using testing data to ensure that the models generalize well to new, unseen data and can be adjusted accordingly in response to the validation. It can be advantageous to jointly train the two models. The composition of the two models should yield an identity function, and this constraint can be used to best train the two models 722, 732 with a joint optimization.

Once the machine learning models 722, 732 have been trained, they can be deployed for use in the phase diversity-based adaptive optics processes for correcting aberrations in a microscope system. For example, the machine learning model 732 can be used to determine the array of voltages to be applied to actuators of the deformable mirror in order to achieve a predetermined phase response (e.g., corresponding to a Zernike mode) from the deformable mirror.

FIG. 7G is a schematic diagram showing relationships between an array of input voltages provided to the actuators of a deformable mirror and phase responses from the mirror to the input voltages. Two rows are shown, with the top row illustrating the response to zero voltage being applied to each of the actuators, and the bottom row illustrating the response to various different voltages being applied to different actuators of the mirror. The leftmost column illustrates the voltages applied to the actuators of the deformable mirror. The next column from the left shows the expected phase response of a wavefront reflected by the mirror according to an assumption that influence functions of the individual actuators are linearly combined to produce the expected phase response. The next column from the left shows the phase response of a wavefront reflected by the mirror as measured by a Shack-Hartmann wavefront sensor. The rightmost column shows the predicted phase response of the mirror, where the prediction is based on a trained machine learning model that predicts the phase response based on the voltages applied to the actuators of the deformable mirror. As seen from FIG. 7G, the machine learning model predictions of the phase response generally more closely approximate the measured phase response, as determined by the Shack-Hartmann sensor, than do the predictions of the phase response based on linear combinations of influence functions for the individual actuators. In addition, the machine learning model predictions generally contain higher spatial frequency information than the estimates of the phase response based on linear combinations of influence functions.

To compare the PD-derived calibration of the deformable mirror 420 more quantitatively to that derived from the SHWFS 430, we conducted more detailed assays in which we inverted the influence functions to obtain control matrices, applied known Zernike aberrations (e.g., Zernike modes 1-20, each with a predefined amplitude, such as, for example, 150 nm) and measured the degree to which the correct aberration agreed with the SHWFS. The SHWFS-calibration provided near ideal performance, and applying the same assay using the PD calibration produced a similar result, albeit with more noise. However, given that the PD calibration used ˜20-fold less fluorescence than the SHWFS, it is perhaps unsurprising that PD produces a noisier result. We found that using particular diversity phases (e.g., astigmatism) produced some improvement in the PD response, suggesting that choice of the type of diversity may also influence PD performance. Incorporating tip/tilt modes into our calibration proved to be beneficial, as characterization assays without tip/tilt compensation were considerably worse. We also found that PD could produce calibrations of similar quality on an extended sample embedded with multiple 500 nm fluorescent beads, which was impossible with the SHWFS calibration scheme as implemented here, since it required a single bead.

In addition, we investigated whether the PD-derived calibration could remove system aberrations by flattening the wavefront measured from our beads, which is an important prerequisite for achieving successful AO correction of an image. To this end, we first used PD to estimate the wavefront from single 500 nm beads (using the same defocus diversities as for the calibration) and found small but non-negligible aberrations. Next, we implemented a feedback scheme in which we used our PD calibration to induce an equal and opposite wavefront to reduce the aberration. This approach reliably reduced the wavefront error to less than 15 nm within a few iterations, also resulting in more symmetric bead images and submicron axial extent.

### Aberration Correction on Extended Samples Using Phase Diversity.

Once the deformable mirror 420 has been calibrated, PD techniques can be used for aberration correction on extended samples, and the performance of the PD techniques can be evaluated.

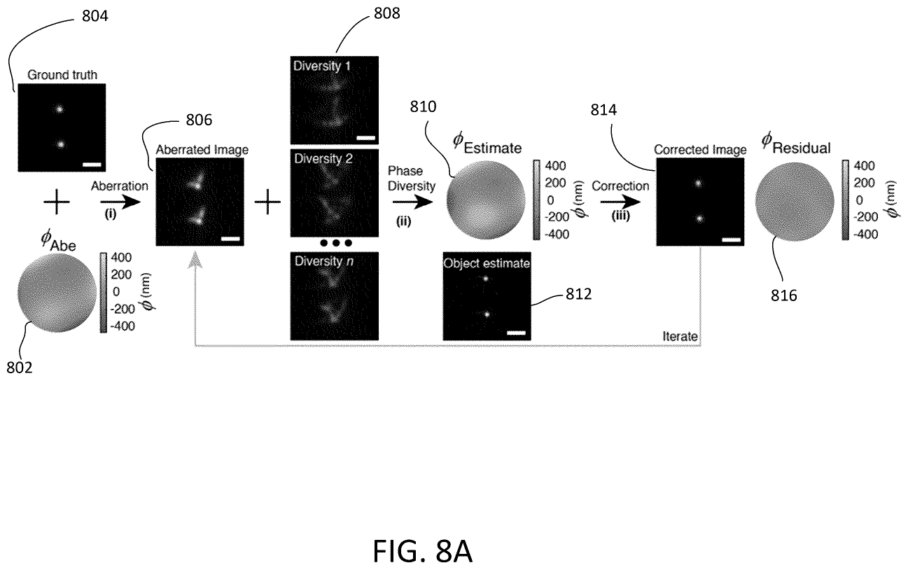

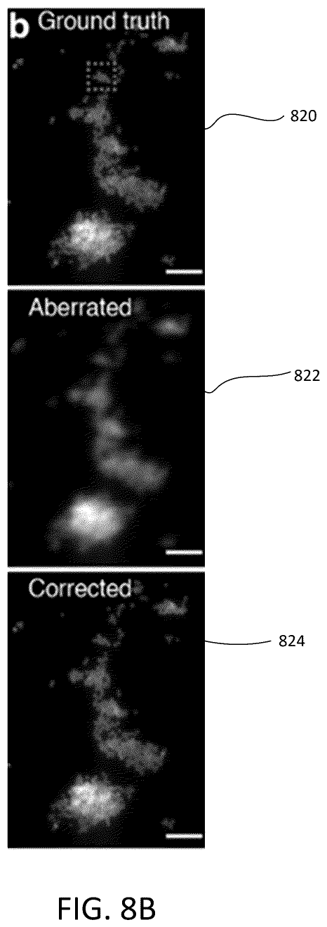

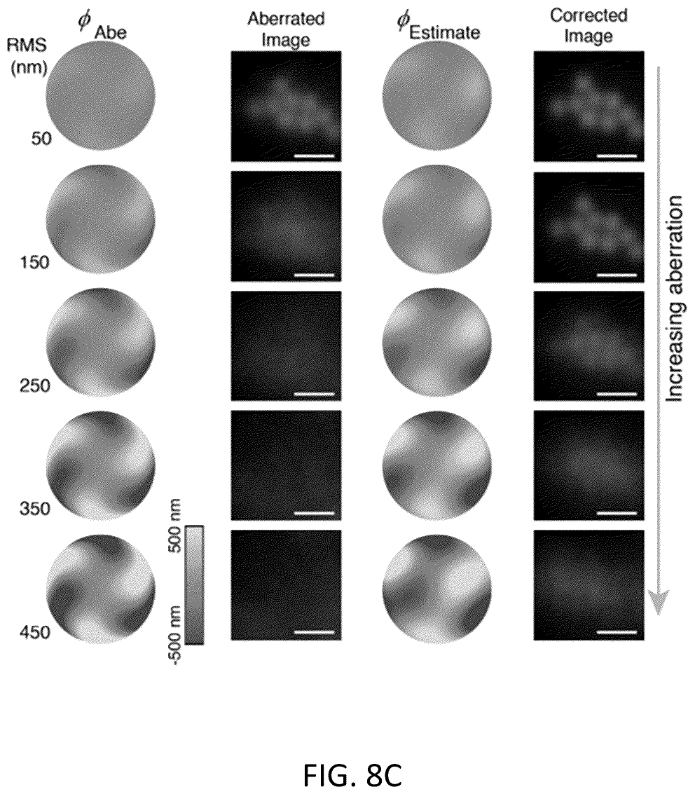

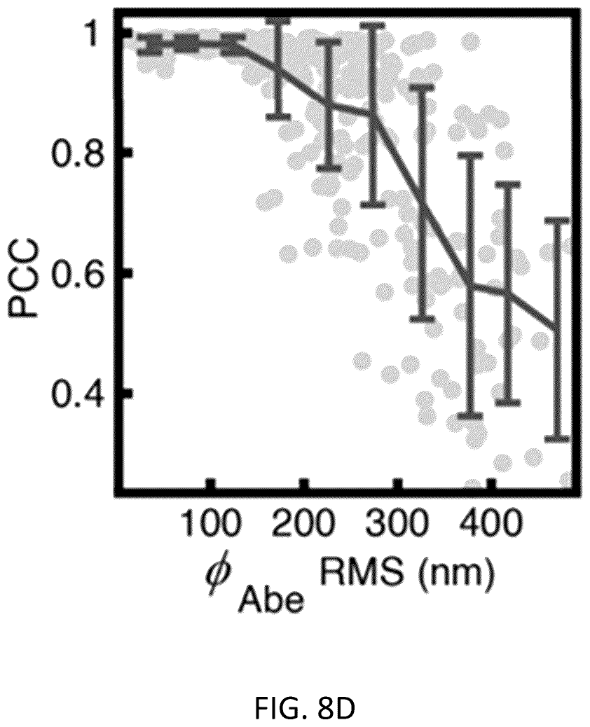

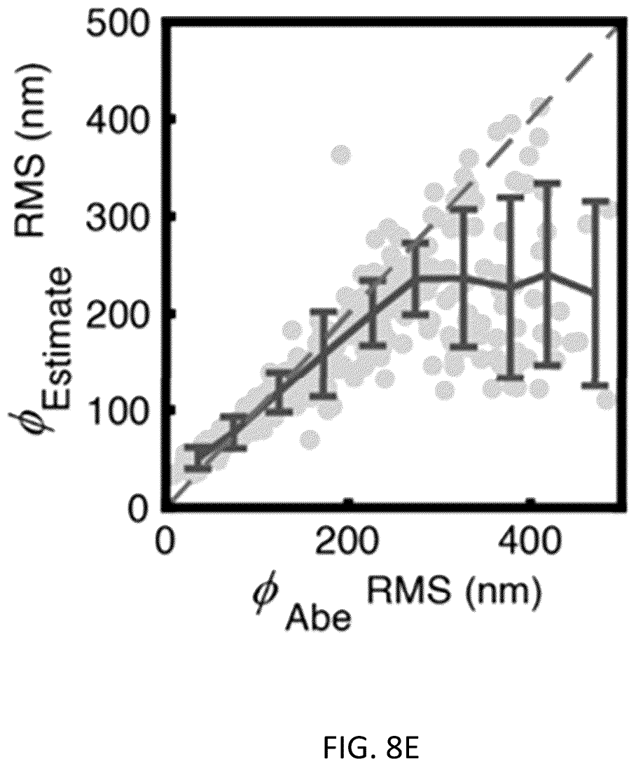

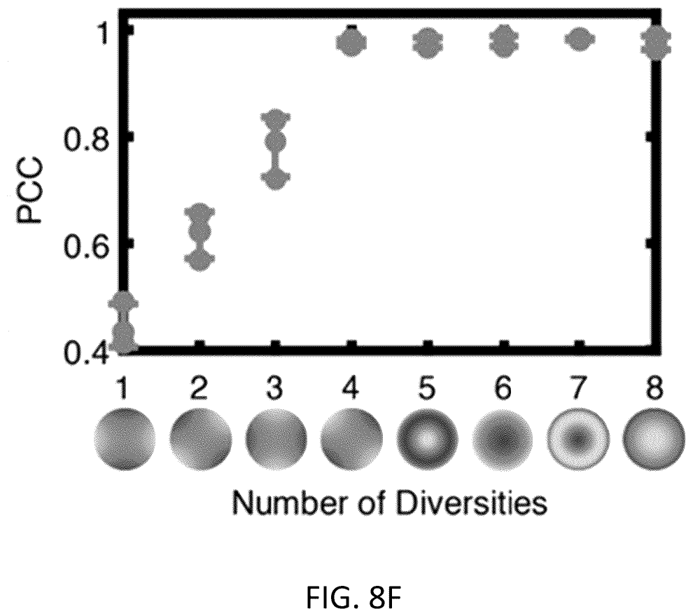

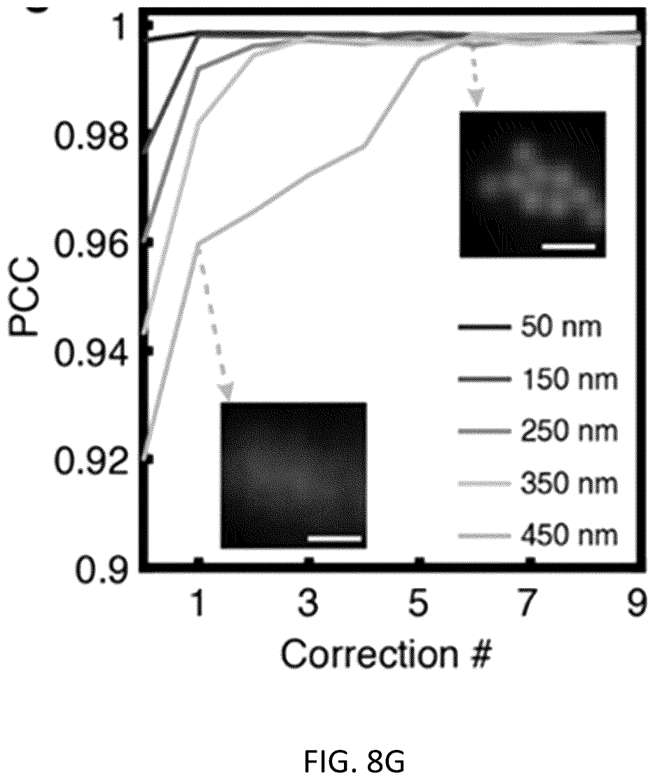

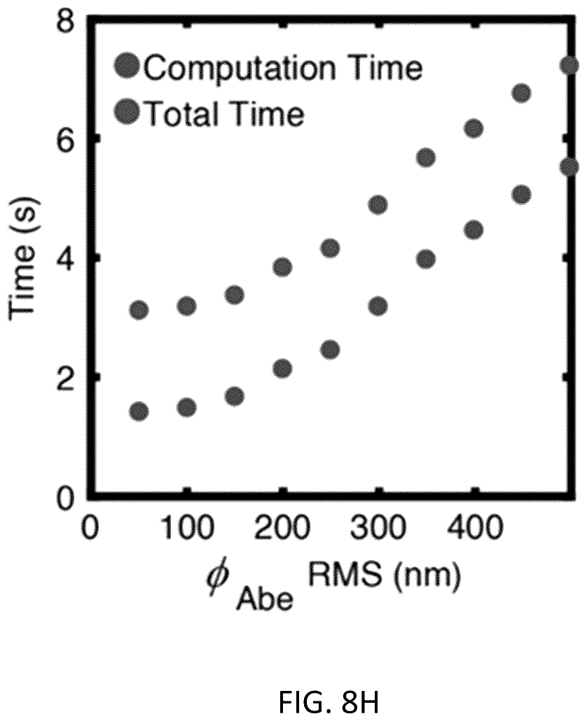

FIG. 8A is a schematic diagram of a process for correcting an aberrated image of an object to remove the aberration. In FIG. 8A known aberrations (ϕ_{Abe}) 802 are introduced to an image of a sample that includes multiple beads, so that instead of imaging an unaberrated ground truth image 804, a raw aberrated image 806 is imaged. The test aberrations ϕ_{Abe} could have different compositions and magnitudes. Then, PD techniques are used to determine the aberration and to correct the aberrations. In particular, a series of diversity images 808 (Diversity 1, Diversity 2, . . . Diversity n) are collected, which are then used to generate 1) an estimate of the unknown wavefront (ϕ_{Estimate}) 810 and 2) an estimate of the object itself 812 using phase diversity techniques. The deformable mirror is then programmed to apply a wavefront modification that is equal but oppositely signed to the estimated unknown wavefront 810, to produce a corrected image 814. Then, the corrected wavefront (ϕ_{Residual}) 816 can be re-measured, and, if desired, additional iterations of the PD process can be performed to produce additional corrections to the wavefront. The scale bars in the images of FIG. 8A are 2 μm.

FIG. 8B shows example images of objects that include 500 nm fluorescent beads with system aberrations corrected 820, after inducing aberration with an RMS wavefront distortion of 150 nm 822, and after one cycle of phase diversity-based AO correction using four diversity images (e.g., having ±1 μm oblique astigmatism and ±1 μm vertical astigmatism) 824. The scale bars in FIG. 8B are 5 μm.

FIG. 8C is an example illustration of the effect of increasingly-strong aberrations. In FIG. 8C, the columns from left to right show: the same test aberration as used in FIG. 8B, with the amount the RMS wavefront distortion being indicated in the figure; a higher magnification view of the associated aberrated subimage, corresponding to red dashed rectangle in FIG. 8B; the estimated wavefront produced by the phase diversity process; and the corresponding image after the phase-diversity-based AO correction is applied. The different rows of FIG. 8C show the effect of increasing the RMS amplitude of ϕ_{Abe}. These results were obtained with a single cycle of wavefront estimation and correction. The scale bars in FIG. 8C are 2 μm.

As shown in FIGS. 8B, 8C, the PD process proved sufficient to restore images contaminated with up to about 200 nm RMS wavefront distortion. At this level of degradation, individual beads were badly blurred and could not be easily discerned in the input aberrated images, yet correction resulted in the same clarity as ground truth images without system or added aberrations. As expected, increasing the magnitude of aberrations caused progressive deterioration in the quality of our correction, noticeable improvement in signal was observed, even when the aberrated images were so blurred that no hint of bead structure remained.

FIG. 8D is a graph assessing the dependence of the Pearson correlation coefficient (PCC, y axis) on the randomly applied aberrations ϕ_{Abe} with the amount the RMS wavefront distortion being indicated on the x-axis. The results are shown for a single cycle of wavefront sensing and correction, where the PCC is measured relative to ground truth images. Individual trials (N=315) are shown as a scatterplot, and mean and standard deviations are also shown, binning points in 50 nm increments. Data are pooled from three different fields of view.

Thus, the PCC between corrected and ground truth images can be useful in characterizing correction performance over a variety of test aberrations. PCC values above ˜0.9 usually were associated with corrections that provided clear improvement over the aberrated input, and most data collected with test aberrations with <250 nm RMS wavefront distortion fell into this category. PCC values below 0.9 usually indicated obvious aberration, although in some cases PCC>0.9 were obtained even for test aberrations with RMS wavefront distortion exceeding 300 nm. In general, the PCC values exhibited a noticeable ‘shoulder’ at ˜250 nm RMS distortion, with an increasingly steep drop and spread in PCC extent below this shoulder.

To better understand this behavior, the wavefront estimate, ϕ_{Estimate}, produced by phase diversity was analyzed. FIG. 8E is a graph that is similar to FIG. 8D but assessing the wavefront estimation by examining the RMS wavefront distortion in the estimated aberration vs. the test aberration. The dashed green line indicates values in which the RMS values of the input test aberration and of the estimated aberration are identical.

If the test aberration ϕ_{Abe} was being accurately sensed, ϕ_{Estimate} would be expected to closely resemble ϕ_{Abe}. When examining the RMS distortion in both quantities, we found that they agreed well until ˜250 nm, where we again observed a ‘shoulder’ beyond which we observed an increasing difference between the RMS values of ϕ_{Estimate} and ϕ_{Abe}. These results suggest that inaccurate wavefront sensing is a primary reason that correction is limited past ˜250 nm RMS test aberration.

Methods to improve performance for aberrations have RMS values >250 nm also were investigated. For example, we explored varying the magnitude of the diversity phases applied to generate the diversity images used in the PD process and found that larger diversity magnitudes generally offered better sensing of the test aberration used to distort the raw image, although sensing still was degraded in the presence of an increasing magnitude of test aberration.

In another example, the effect of the number and type of diversity phases used to generate diversity images (e.g., by using different Zernike modes as the different diversities) was investigated. FIG. 8F is a graph showing the quality of images resulting from a single correction (as assessed by PCC, y-axis) as a function of the number of diversity phases (x-axis) used in wavefront estimation. The test aberration used to generate the data for FIG. 8F had the same shape as the aberration in FIGS. 8B, 8C, with an RMS distortion of 236 nm. Individual data points are shown in FIG. 8F as well as means and standard deviations from three independent imaging fields. Diversity phases (±1 μm amplitude oblique astigmatism, horizontal astigmatism, defocus, and spherical aberration) are indicated below the x-axis.

Thus, using a test aberration with 250 nm RMS wavefront distortion, FIG. 8F indicates that that performance improved up to four diversity phases and then plateaued, at least for the choice of diversities tried here.

In addition, we explored the effect of multiple iterations of wavefront sensing and correction on the final corrected image. FIG. 8G is a graph showing a quality of correction (PCC, y-axis) as a function of number of correction cycles (x-axis) for aberrations ϕ_{Abe} with RMS wavefront distortions of 50 nm, 150 nm, 250 nm, 350 nm, 450 nm using the same data in in FIGS. 8B and 8C. In FIG. 8G, insets with dashed arrows show first and sixth correction with 450 nm RMS wavefront distortion in ϕ_{Abe}, and the scale bars in the insets are 2 μm. Thus, as indicated in FIG. 8G, it was possible to fully correct larger aberrations (up to 450 nm RMS distortion) by increasing the number of correction cycles from one to five or more.

FIG. 8H is a graph showing the total time (red) and the computational time (blue) for performing a first correction iteration as a function of the RMS magnitude of ϕ_{Abe}. The computational time scales nonlinearly as a function of RMS magnitude, whereas acquisition, file saving, and instrument overhead contribute a fixed time cost (here about 1.7 s). Thus, the time required for a single iteration of wavefront sensing and correction depended on the magnitude of the aberration of the image, with larger aberrations requiring more time. For test aberrations with RMS wavefront distortions <250 nm, the computational burden associated with wavefront sensing was on par with acquisition related timing (fixed at 1.7 s, including file saving and hardware-related delays). For larger aberrations, the computational burden was several-fold larger. Nevertheless, given anticipated improvements in both data acquisition and algorithmic efficiency, we expect that the second-level time resolution for typical imaging fields (e.g., 512×512 pixels, ˜53×53 μm²) should be achievable.

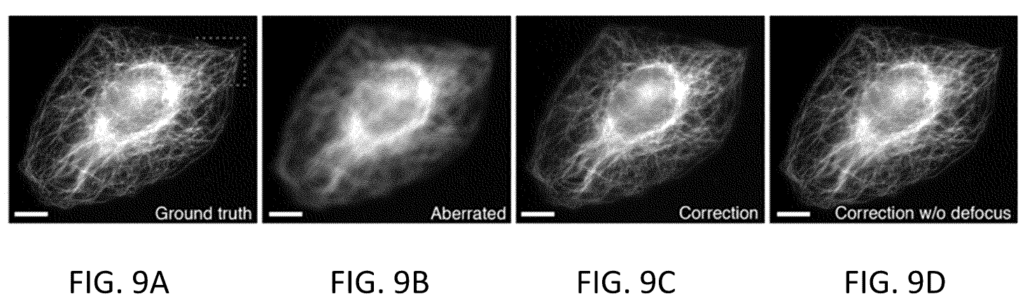

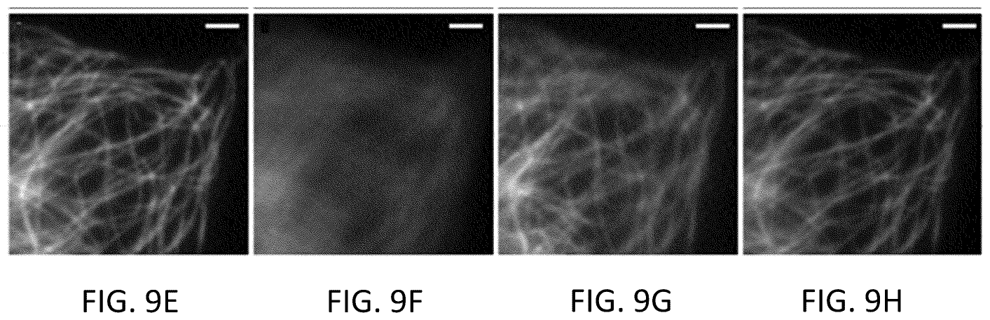

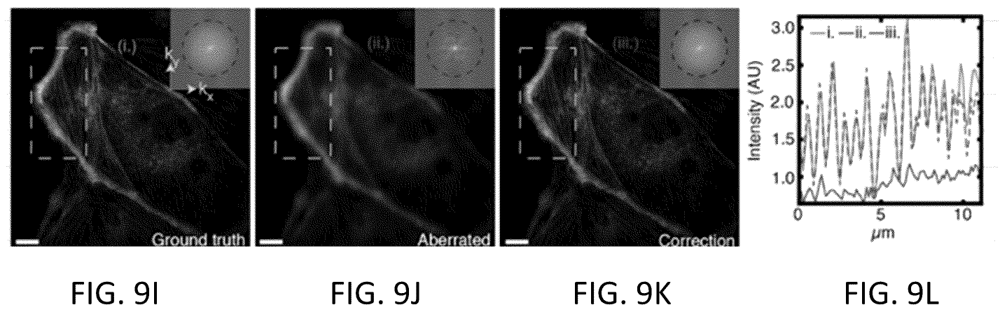

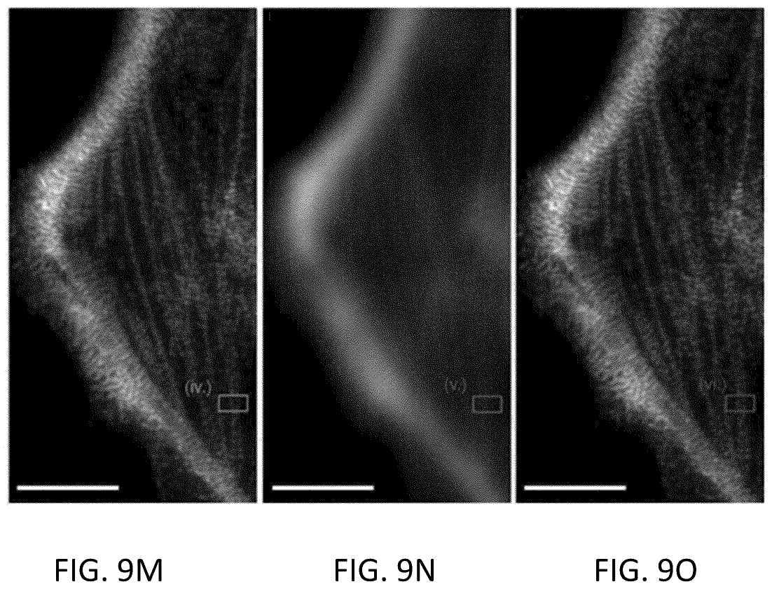

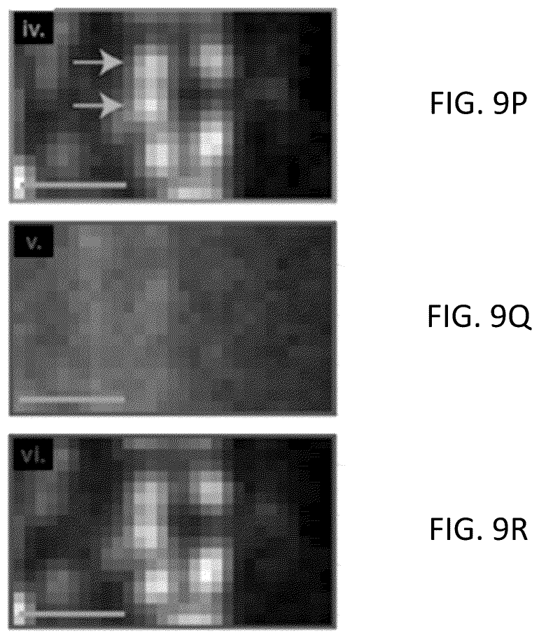

In addition to the implementations described above, phase diversity-based wavefront sensing also can be used for AO correction on cellular samples. FIGS. 9A-9P illustrate the application of phase diversity-based wavefront sensing for use in AO correction on cellular samples.

FIGS. 9A, 9E are ground truth images of U2OS cells that were fixed and immunostained for microtubules, and FIGS. 9B, 9F are distorted images of the U2OS cells in which a 219 nm RMS wavefront distortion was added to blur the images to the extent that individual fibers were indiscernible. Then, PD was used to sense the aberrated wavefront, and the sensed aberrated wavefront was used to dramatically improve image quality of the blurred images with only two correction cycles, largely restoring the appearance of microtubule fibers as seen in the images of FIGS. 9C, 9G. Close inspection of the corrected images in FIGS. 9C, 9G shows that the correction was incomplete, with somewhat worsened image quality compared to the ground truth images of FIGS. 9A, 9E. These suboptimal results may be due mainly to the out-of-focus fluorescence light, which is a consequence of widefield illumination and detection on these 3D samples. The PD algorithm used to generate the corrected images of FIGS. 9C, 9G does not account for the 3D nature of the object and likely misinterprets the light from such a 3D object as out-of-focus background light as well as other aberrations. To compensate for such effects, the PD algorithm can be adapted to intentionally neglect to correct the defocus Zernike mode as shown in FIG. 9D, and the resulting AO correction without defocus produced better restoration than the full AO correction as shown in the image of FIG. 9H, as compared with the image of FIG. 9G. This suggests that PD algorithm can perform well on microscope systems with optical sectioning.

As another test case more suited to the widefield microscope employed here, we examined immunostained myosin in fixed Ptk2 cells. As these samples were much thinner (generally of submicron thickness) than the samples imaged in FIGS. 9A and 9E, they provided a closer approximation to a 2D biological sample than the U2OS cells. Myosin is also known to assemble into bipolar filaments of length ˜300 nm in vitro and in cells, providing an additional test of the resolution of our system.

FIGS. 9I, 9M, and 9P are ground truth images of immunostained myosin in fixed Ptk2 cells captured by a widefield microscope, where FIG. 9M includes a detailed image of portion of the image of FIG. 9I, and where FIG. 9P includes a detailed image of portion of the image of FIG. 9M. FIGS. 9J, 9N, and 9Q are images of the immunostained myosin in fixed Ptk2 cells where the images have been aberrated by 311 nm RMS wavefront distortion, where FIG. 9N includes a detailed image of portion of the image of FIG. 9J, and where FIG. 9Q includes a detailed image of portion of the image of FIG. 9N. FIGS. 9K, 9O, and 9R are AO corrected images of the immunostained myosin in fixed Ptk2 cells, where PD was used to estimate the aberration and a phase map was applied to the deformable mirror to cancel the estimated aberration, where FIG. 9O includes a detailed image of portion of the image of FIG. 9K, and where FIG. 9R includes a detailed image of portion of the image of FIG. 9O. The corrected images in FIGS. 9K, 9O, and 9R are generated based on two iterations of the PD aberration correction process.

In the ground truth images of FIGS. 9I and 9M, periodic striations of myosin along stress fibers were resolved, with individual puncta sized ˜300 nm or above. While the separation between bipolar myosin heads could not be universally resolved, Fourier transforms revealed spectral density out to ˜300 nm (See the inset of FIG. 9I), and we occasionally did find puncta separated at ˜300 nm, as shown in FIG. 9P. By contrast, introducing the aberrations with 311 nm RMS wavefront distortion reduced the spatial resolution to the point that myosin striations (See FIG. 9L, 9N) or individual puncta (See FIG. 9Q) were completely absent.

Thus, FIGS. 9A-9H show the usefulness of phase diversity-based AO on biological samples. For example, FIGS. 9A-9D show images of U2OS cells that were fixed and immunostained for microtubules, where ground truth images are shown in FIG. 9A, images aberrated with 219 nm RMS wavefront distortion are shown in FIG. 9B, images of the cells after resulting AO correction (using two correction cycles) are shown in FIG. 9C, and AO-corrected images of the cells, but without defocus correction (also using two correction cycles), are shown in FIG. 9D. FIGS. 9E-9H show higher magnification views corresponding to the red dashed rectangular region in FIG. 9A.

FIGS. 9I-9K are images of Ptk2 cells that were fixed and immunolabeled against myosin heavy chain, where ground truth images are shown in FIG. 9I, images aberrated with 311 nm RMS wavefront distortion are shown in FIG. 9J, and images that were corrected after measuring wavefront distortion with phase diversity are shown in FIG. 9K (using two correction cycles). Insets show Fourier transform magnitudes (displayed after logarithmic transformation), with the dashed circle indicating 1/300 nm⁻¹ spatial frequency. FIG. 9L shows a line profile comparison along the green line (i), the red line (ii), and the magenta line (iii) in FIGS. 9I-9K, showing that AO correction recovers peak profiles that are absent in the aberrated image. FIGS. 9M-9O show higher magnification views of dashed rectangular regions in FIGS. 9I-9K. FIGS. 9P-9R show higher magnification views of green (iv), red (v), and magenta (vi) rectangles in FIGS. 9M-9O. Cyan arrows highlight puncta separated by ˜300 nm that are resolved in ground truth images, absent in aberrated image, and recovered in the AO corrected image. The scale bars are 10 μm in FIGS. 9A-9D, 9I-9K, and 9M-9O. The scale bars are 2 μm in FIGS. 9E-9H. The scale bar is 1 μm in FIGS. 9P-9R.

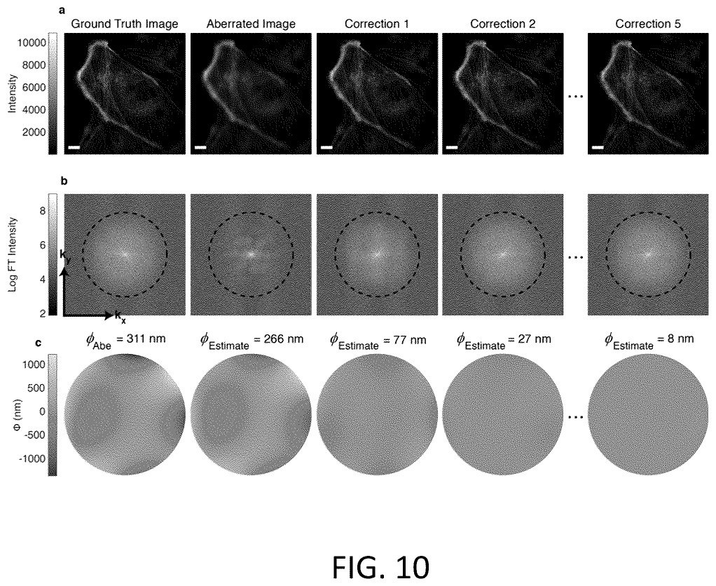

FIG. 10 is a schematic diagram illustrating the effect of multiple iterations of sensing with phase diversity to estimate an aberration of a wavefront and then applying an adaptive optics correction with a wavefront modulating element. The first row of five images shows, from left to right, the ground truth image, an aberrated image, an AO-corrected image that is based on one PD correction iteration, an AO-corrected image that is based on two PD correction iterations, and an AO-corrected image that is based on five PD correction iterations. The scale bar in the images represents a 10 μm distance. The second row of five images shows, from left to right, corresponding plots of the logarithm of magnitude of the Fourier transform of the image directly above. Dashed circles in the images of the second row indicate 1/300 nm⁻¹. The third row of five images shows, from left to right, the phase of the aberrated wavefront (ϕ_{Abe}) and the estimated wavefronts (ϕ_{Estimate}) based on PD corresponding to aberrated and corrected images. The RMS wavefront distortions are indicated above each wavefront. As is evident from FIG. 10, additional cycles of correction significantly improve the AO correction of the aberration of an image.

Referring again to FIG. 4, the microscope system 400 is controlled by one or more computing devices 450, and images collected by the system are analyzed by the one or more computing devices 450 to estimate a wavefront and to perform AO corrections for images collected with the system. In some implementations, the microscope system 400 was controlled using a custom-designed program in LabVIEW Version 2023 Q1 that executed program code to control of the detector 426, to control of the Shack-Hartmann sensor 430, and to control the deformable mirror 420. The Lab VIEW program also controlled the Piezo stage 418, the laser shutter 404, and the motorized flipper mount for the flip mirror 432.

Significant aberration can be introduced when the deformable mirror 420 has no voltage applied to its actuators. A voltage offset can be applied to each actuator to cancel these and other sources of system aberrations, a process that can be referred to as “flattening” the mirror. This offset then serves as the base set of voltages to which all other voltages are added to. Such offsets were used for all experiments. An initial set of voltages is typically provided by the deformable mirror manufacturer, but this offset does not account for any other sources of system aberration or longer-term drift. An updated flat configuration of the mirror was generated using the AO correction loop procedure described herein.

The goal of the phase diversity algorithm is to take the input diversity images, their corresponding known diversity wavefronts, and parameters of the system (including numerical aperture of the objective 414, image pixel size, and central emission wavelength of the light source 402 and return an estimate of the unknown wavefront.

When performing on-line wavefront estimation, Lab VIEW can initiate the algorithm using a MATLAB script node which calls a MATLAB wrapper function (“processPhaseDiversityImages”) which passes the inputs from Lab VIEW to MATLAB and calls the function chain for the algorithm to return an estimate of the unknown wavefront. This set of functions performs a series of pre-processing steps, passes the resulting inputs to the algorithm, and returns the wavefront and object estimates as outputs which are passed back to Lab VIEW.

A computational approach to phase diversity-based AO correction can be pursued in which the phase error in a microscope system is represented as an expansion in Zernike polynomials and the vector of coefficients of those polynomials is estimated. Because the use of a finite number of Zernike polynomials naturally leads to a reasonably smooth phase map, we can omit a regularization that is applied to a phase map used to correct for random temporal fluctuations in a viewing system.

We begin by establishing notation and the problem formulation. The pupil function Hₖ(u) for the k^{th} diversity image is given by:

$${H}_{k} ( u ) = \vert P ( u ) \vert {e}^{i ϕ ( u ) + i {θ}_{k} ( u )} ,$$

where u is a 2D pupil plane coordinate. Here ϕ(u) is the unknown phase aberration and θₖ(u), k=1 . . . , K, is the k^{th} known, purposefully introduced aberration. |P(u)| is a binary pupil mask given by:

$$P ( u ) = 0 for u > \frac{N A}{λ} .$$

The inverse Fourier transform of Hₖ(u) is denoted by hₖ(x), where x is the 2D spatial domain coordinate conjugate to u. For fluorescence imaging, the incoherent PSF will be given by

$${s}_{k} ( x ) = {\vert {h}_{k} ( x ) \vert}^{2} .$$

The imaging model for the data acquired for the k^{th} diversity image dₖ (x) is then given by

$${d}_{k} ( x ) = {s}_{k} ( x ) * f ( x ) + n ( x ) .$$

Here, f(x) is the unknown object of interest and n(x) is additive noise.

The goal is to determine both f(x), the unknown object, and ϕ(u), the unknown phase aberration. We assume ϕ(u) can be expressed as the expansion of a finite number M of Zernike polynomials ϕm(u):

$$ϕ ( u ) = {\sum }_{m = 1}^{M} {c}_{m} {ϕ}_{m} ( u ) .$$

Thus, the ultimate aim is to determine the M×1 vector c of coefficients that best represents the phase map ϕ, as well as the unknown object f(x).

To find the phase map ϕ (by finding the vector of coefficients c) and the object f(x), we seek to minimize a Tikohonov-regularized least-squares objective function:

$$J = J [ ϕ , f ] = \frac{1}{2} ( {\sum }_{k = 1}^{K} {\int }_{{ℝ}^{2}} {[ ( {s}_{k} * f ) ( x ) - {d}_{k} ( x ) ]}^{2} d x ) + \frac{γ}{2} {\int }_{{ℝ}^{2}} {f ( x )}^{2} d x .$$

It has been shown that there is a closed-form expression for the Fourier transform of an object, given an estimate of the phase map and the associated PSFs,

$$F [ ϕ ] = \frac{{\sum }_{k = 1}^{K} {S}_{k}^{*} [ ϕ ] {D}_{k}}{γ + {\sum }_{k = 1}^{K} {\vert {S}_{k} [ ϕ ] \vert}^{2}} ,$$

where Dₖ are the Fourier transforms of the phase diversity images, F[ϕ] is the Fourier transform of the object f(x) and

$${S}_{k} [ ϕ ] = ℱ \{ {s}_{k} [ ϕ ] \}$$

is the Fourier transform of the PSF. Note that for compactness we have dropped the explicit dependence on spatial position x and spatial frequency u but do preserve explicit dependence on ϕ, which will be important to keep track of below when taking derivatives with respect to ϕ.

This allows the unknown object to be eliminated from the objective function, which can be reformulated, in Frequency space, just in terms of the unknown phase map.

$$J = {\sum }_{1}^{K} {\vert {D}_{k} \vert}^{2} - \frac{{\sum }_{1}^{K} {\vert {D}_{k}^{*} {S}_{k} [ ϕ ] \vert}^{2}}{{\sum }_{1}^{K} {\vert {S}_{k} [ ϕ ] \vert}^{2} + γ} \qquad ( 2 )$$

To determine the phase map, a Gauss-Newton method that is both fast and robust can be used. It starts with an initial guess of the Zernike coefficients (often c=0), with the update equation for the coefficients for iteration q+1 from iteration q given by

$${c}^{( q + 1 )} = {c}^{( q )} + Δ c$$

$$where$$

$$Δ c = - {H}^{- 1} g .$$

Here g is the M×1 gradient vector of the objective function and H is an M×M approximate Hessian (second derivative) matrix of the objective function.

The expression for the gradient is given by

$$g [ ϕ ] = - 2 {\sum }_{k = 1}^{K} Imag \{ {H}_{k}^{*} [ ϕ ] ℱ \{ {h}_{k} [ ϕ ] Real \{ {ℱ}^{- 1} \{ {V}_{k} [ ϕ ] \} \} \} \} . \qquad ( 3 )$$

In the above, Imag{w} denotes the imaginary part of a complex random variable w, Real{w} the real part, and [symbol] and [symbol] ⁻¹ denote the Fourier transform and its inverse, respectively. Also,

$${V}_{k} [ ϕ ] = {F}^{*} [ ϕ ] {D}_{k} - {\vert F [ ϕ ] \vert}^{2} {S}_{k} [ ϕ ] .$$

The gradient has dimensions of the number of pixels in an image. To get the gradient with respect to the vector of coefficients c, we simply need to take the inner product of the gradient in Eqn. 3 with the Zernike polynomials:

$${g}_{m} = 〈 g [ ϕ ] , {ϕ}_{m} 〉 , m = 1 , … M .$$

So, to calculate the gradient vector, one needs to:
1. For k=1, . . . K, calculate the Dₖ (FTs of the measured phase diversity images)
2. For current estimate of c, calculate

$$ϕ = {\sum }_{m = 1}^{M} {c}_{m} {ϕ}_{m}$$

3. For k=1, . . . K, calculate Hₖ[ϕ]=|P|e^{iϕ+iϕ}^{ₖ}
4. For k=1, . . . K, calculate hₖ[ϕ] by taking the inverse FFT of Hₖ[ϕ]
5. For k=1, . . . K, calculate sₖ[ϕ]=|hₓ[ϕ]|²
6. For k=1, . . . K, calculate Sₖ[ϕ] by taking the FFT of sₖ[ϕ]
7. Calculate F using the closed-form expression above
8. Calculate Vₖ[ϕ]=F*[ϕ]Dₖ−|F[ϕ]|²Sₖ[ϕ]
9. Calculate [symbol] ⁻¹{Vₖ[ϕ]} as needed for the gradient expression
10. Evaluate the gradient expression
11. Take the inner product with all M Zernike polynomials to build gradient vector g.

To obtain the M×M Hessian matrix H, we first adapt Eqn. 26 of Vogel, C. R., Chan, T. F. & Plemmons, R. J., “Fast algorithms for phase-diversity-based blind deconvolution.” Proc. SPIE 3353, Adaptive Optical System Technologies (1998), which says that we can form the elements of H by acting with the operator H on each of the M Zernike polynomials and then taking inner products of the resulting M vectors with each of the M Zernike polynomials.

$${H}_{mn} = 〈 {H}_{GN} [ ϕ ] {ϕ}_{n} , {ϕ}_{m} 〉$$

H_{GN}[ϕ]ϕₙ can be evaluated as:

$${H}_{GN} [ ϕ ] {ϕ}_{n} = 4 {\sum }_{k = 1}^{K} {\sum }_{j = 1}^{k - 1} I mag \{ {H}_{j}^{*} [ ϕ ] ℱ \{ {h}_{j} [ ϕ ] {ℱ}^{- 1} \{ {\tilde{D}}_{k}^{*} {\tilde{U}}_{jk} \} \} - {H}_{k}^{*} [ ϕ ] ℱ \{ {h}_{k} [ ϕ ] {ℱ}^{- 1} \{ {\tilde{D}}_{j}^{*} {\tilde{U}}_{jk} \} \} \} ,$$

$$where$$

$${\tilde{U}}_{jk} = {\tilde{D}}_{j} ℱ \{ Imag \{ {h}_{k}^{*} [ ϕ ] {ℱ}^{- 1} \{ {H}_{k} [ ϕ ] {ϕ}_{n} \} \} \} - {\tilde{D}}_{k} ℱ \{ Imag \{ {h}_{j}^{*} [ ϕ ] {ℱ}^{- 1} \{ {H}_{j} [ ϕ ] {ϕ}_{n} \} \} \} ,$$

$$with$$

$${\tilde{D}}_{j} = \frac{{D}_{j}}{{Q}^{1 / 2}}$$

$$and$$

$$Q [ ϕ ] = γ + {\sum }_{k = 1}^{K} {\vert {S}_{k} [ ϕ ] \vert}^{2} .$$

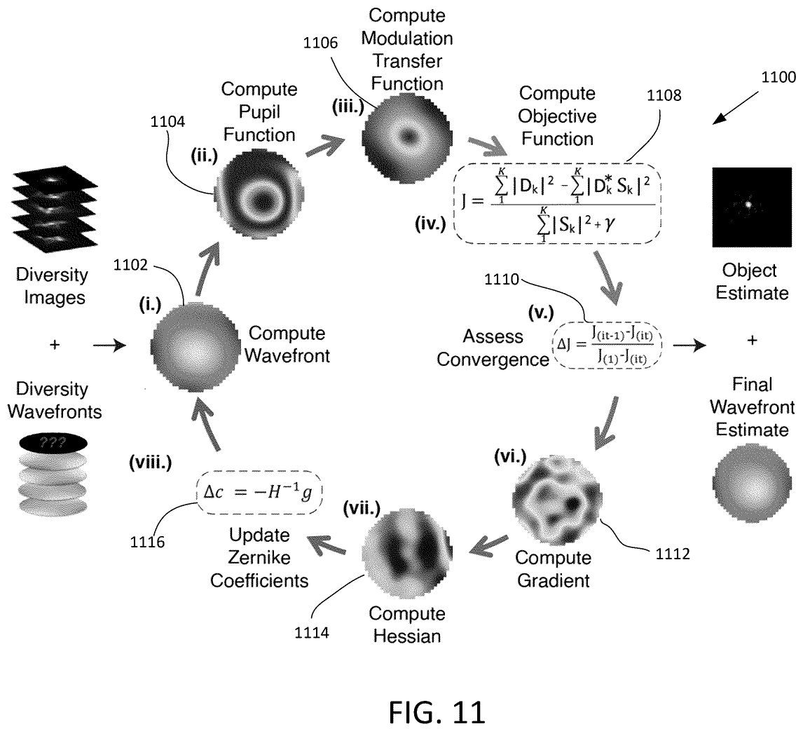

FIG. 11 illustrates an example workflow 1100 for estimating the wavefront. First in the workflow is the function (“reconstructZernikeAberrations”) that initiates data pre-processing and passes this result as input to the algorithm function. Image pre-processing is handled by a function (“fileIO_lvtiff2mat”) that transfers the saved detector images from disk into MATLAB. In some implementations, the full-frame images are loaded from disk, cropped to the intended size for processing, a constant background value is subtracted, and an edge-tapering is applied using a Gaussian smoothing kernel with size 10×10 pixels and standard deviation 3 pixels. Additional pre-processing steps can be performed by a function (“zernretrieve_pre”) in which the images passed from fileIO_lvtiff2mat are Fourier transformed, and then the Zernike polynomial functions for the modes to be estimated are computed, and finally, wavefronts corresponding to the diversity phases are constructed from their known coefficients. The pre-processed data and parameters are then passed as inputs to the algorithm function, zernretrieve_loop (1102).

Each loop of the workflow (1100) starts by setting the wavefront to the previous iteration's wavefront estimate (in the first iteration, the wavefront is set to zero). The process computes the pupil function (1104) and the modulation transfer function (1106). Then, the algorithm function, zernretrieve_loop, can use an optimization function, for example, Gauss-Newton optimization, to find the wavefront that minimizes an objective function, J (1108). In frequency space, the objective function, J, is given in terms of the optical transfer functions (OTFs) (Sₖ), the modulation transfer functions (MTFs) (|Sₖ|), and the frequency-space diversity images (Dₖ):

$$J = {\sum }_{1}^{K} {\vert {D}_{k} \vert}^{2} - \frac{{\sum }_{1}^{K} {\vert {D}_{k}^{*} {S}_{k} [ ϕ ] \vert}^{2}}{{\sum }_{1}^{K} {\vert {S}_{k} [ ϕ ] \vert}^{2} + γ} , \qquad ( 4 )$$

with γ being a regularization term set to 1×10⁻⁶ (as determined from simulations) and * denoting the complex conjugate.

The final wavefront estimate (or each iteration of the wavefront estimate) can be expressed in a basis of M Zernike polynomials, and the Zernike coefficients c can be updated by computing the gradient, g, (an M×1 vector) (1112) and computing the pseudo-Hessian, H, (an M×M matrix) of the Gaussian likelihood function (1114). The update equation to update the Zernike coefficients (1116) for iteration q+1 from iteration q is given by:

$${c}^{( q + 1 )} = {c}^{( q )} + Δ c \qquad ( 5 )$$

$$Δ c = - {H}^{- 1} g .$$

In practice, the wavefront is initialized by setting all coefficients to zero, c⁽⁰⁾=0.

We evaluate J for convergence (1110) by comparing the marginal change in/to the total change since iteration began. Further iteration is terminated if this quantity is less than 0.001, if J begins increasing, or if a maximum number of iterations (e.g., 100) is reached.

$$Δ J = \frac{\vert {J}^{( q + 1 )} - {J}^{( q )} \vert}{\vert {J}^{( 0 )} - {J}^{( q )} \vert} \qquad ( 6 )$$

To construct the gradient (1112), we evaluate

$$g [ ϕ ] = - 2 {\sum }_{k = 1}^{K} I mag \{ {H}_{k}^{*} [ ϕ ] ℱ \{ {h}_{k} [ ϕ ] Real \{ {ℱ}^{- 1} \{ {V}_{k} [ ϕ ] \} \} \} \} \qquad ( 7 )$$

$$where$$

$${V}_{k} [ ϕ ] = {F}^{*} [ ϕ ] {D}_{k} - {\vert F [ ϕ ] \vert}^{2} {S}_{k} [ ϕ ] .$$

To reduce the dimensionality and obtain the gradient in terms of a reduced set of Zernike coefficients, we take the inner product between this gradient and the Zernike polynomials to produce an M×1 gradient vector.

The Hessian H is constructed (1114) by calculating the elements of the matrix as

$${H}_{mn} = 〈 {H}_{GN} [ ϕ ] {ϕ}_{n} , {ϕ}_{m} 〉 . \qquad ( 8 )$$

Following Vogel, C. R., Chan, T. F. & Plemmons, R. J., “Fast algorithms for phase-diversity-based blind deconvolution.” Proc. SPIE 3353, Adaptive Optical System Technologies (1998), which is incorporated herein by reference, this expression can be evaluated as:

$${H}_{GN} [ ϕ ] {ϕ}_{n} = 4 {\sum }_{k = 1}^{K} {\sum }_{j = 1}^{k - 1} Imag \{ {H}_{j}^{*} [ ϕ ] ℱ \{ {h}_{j} [ ϕ ] {ℱ}^{- 1} \{ {\tilde{D}}_{k}^{*} {\tilde{U}}_{jk} \} \} - {H}_{k}^{*} [ ϕ ] ℱ \{ {h}_{k} [ ϕ ] {ℱ}^{- 1} \{ {\tilde{D}}_{j}^{*} {\tilde{U}}_{jk} \} \} \} \qquad ( 9 )$$

$$where$$

$${\tilde{U}}_{jk} = {\tilde{D}}_{j} ℱ \{ Imag \{ {h}_{k}^{*} [ ϕ ] {ℱ}^{- 1} \{ {H}_{k} [ ϕ ] {ϕ}_{n} \} \} \} - {\tilde{D}}_{k} ℱ \{ Imag \{ {h}_{j}^{*} [ ϕ ] {ℱ}^{- 1} \{ {H}_{j} [ ϕ ] {ϕ}_{n} \} \} \} , \qquad ( 10 )$$

$${\tilde{D}}_{j} = \frac{{D}_{j}}{{Q}^{1 / 2}} , \qquad ( 11 )$$

$$and$$

$$Q [ ϕ ] = γ + {\sum }_{k = 1}^{K} {\vert {S}_{k} [ ϕ ] \vert}^{2} . \qquad ( 12 )$$

To speed up this computation, the calculations can be performed on a GPU using MATLAB's gpuArray functionality. Further, the calculations can be optimized by avoiding looping over the sums, but instead calculating the terms in Eqn. 12 for all indices in parallel. As the outer sum is taken from k=1 to K, and the inner sum from j=1 to k−1, we first determined all required index pairs and then calculated the required pairs only.

To further increase the computation speed, the calculation of the Zernike polynomials can be implemented as a handle class, i.e., all required Zernike polynomials can be calculated only once and then cached, to avoid duplicated computation. The aberrations in each iteration are then computed by multiplying the new coefficient estimates with the precomputed Zernike polynomials.

Finally, still referring to FIG. 11, the coefficients are updated (1116) using the previous coefficients, the Hessian, and the gradient using Eqn. 5.

Our implementation can estimate a wavefront in ˜100 ms (e.g., for the 128×128 crops around a single bead used for calibration of the deformable mirror 420), with time cost generally increasing in proportion to the image area (e.g., on the seconds level for the first correction cycle in the multi-bead tests described above). We also found that computational cost increased as the magnitude of wavefront distortion increased.

### Phase Diversity-Based Calibration of the Deformable Mirror

The deformable mirror calibration procedure was implemented using the custom Lab VIEW program described above. To acquire the control matrix, negative and positive voltages (±0.03 V) were applied to a single actuator and image stacks were acquired with axial stage positions ±2 μm, ±1 μm, 0 μm, with each axial defocus used as a diversity phase. Images were exposed for 30 ms for each voltage value at each stage position, and overall acquisition time was minimized by moving the stage during the camera readout period, resulting in a total time of 1.03 s per actuator, including moving the stage, exposing, readout, and switching mirror voltages. This process was repeated for each of the 52 mirror actuators. After acquisition, the influence functions for all 52 actuators were computed off-line using MATLAB.

To reduce readout time, images were acquired with a cropped sensor mode of 512×512 pixels. For deformable mirror calibrations featuring a single bead, images were further cropped to a size of 128×128 pixels to minimize processing time. For calibrations featuring multiple beads the full 512×512 acquisition size was used.

Off-line Phase Diversity processing is performed using the script script_Calibration. When using stage defocus, we compute the high NA defocus phase corresponding to each stage position:

$$( 13 )$$

$$ϕ ( u , v , Z ) = Z [ \frac{2 π n}{λ} \sqrt{1 - {( \frac{λ}{n} )}^{2} ( {u}^{2} + {v}^{2} )} ] where u , v ranges from 0 \to \frac{NA}{λ}$$

and use these phases as the diversity phases in reconstructZernikeAberrations, subsequently estimating the wavefront as described above. After estimating the wavefront for each voltage for a given actuator, the influence function for each of the 52 actuators is computed from the slopes of each coefficient value given by Eqn. 14:

$${IM}_{Z , A} = \frac{{dc}_{Z}}{{V}_{2} - {V}_{1}} \qquad ( 14 )$$

where IM_{Z,A} is the interaction matrix slope value representing the change in Zernike coefficient for mode Z, dc_{Z}, as a deformable mirror actuator, A, changes voltage from V₁ to V₂. In all cases here we used V₁=−0.03V and V₂=+0.03V. After all values have been computed the control matrix is obtained by pseudo-inverting the interaction matrix using the MATLAB function pinv with a tolerance value of 0.005.
Deformable Mirror Calibration with Alternative Diversity Phase

In some experiments, we calibrated the deformable mirror by using astigmatism as a diversity phase, finding that this choice gave lower off-target noise than our stage defocus-based calibration. In this case, the applied astigmatism commands were derived from a previous calibration, and we used four permutations of horizontal or oblique astigmatism with values of ±1 μm as our diversities. In addition to the offset voltage and diversity phase voltages, we added additional voltages (−0.03V/±0.03V) to the actuator being measured. Wavefronts were measured using the on-line wavefront estimation procedure described above. Off-line processing was performed to obtain the influence functions from the slope of the individual wavefronts for each actuator and to calculate tip/tilt from the object estimates as was done in the standard PD deformable mirror calibration procedure.

### Estimating Tip and Tilt

Tip and tilt are first-order Zernike modes that represent vertical and horizontal translations in the image plane. These wavefront components are not accounted for by the phase diversity algorithm but are critical to include in deformable mirror calibration to ensure that image translations are not inadvertently included when applying commands. To estimate residual tip/tilt that arise when different voltages are applied to the deformable mirror, we rely on object estimates produced by PD, whereby relative differences in tip/tilt manifest as displacements in object position resulting from the different voltages.

To estimate displacement between object estimates, we computed their cross-correlation with sub-pixel accuracy using a single-step discrete Fourier transform algorithm. The computed shift in each axis, pⱼ, is given in units of pixels, which can be converted to units in pupil space to be incorporated into our control matrix. To determine the appropriate conversion factor, we simulated object estimates with different magnitudes of tip/tilt. Computing the translation as a function of tip/tilt Zernike coefficient amplitude yields the conversion factor, δ, of 0.8352 μm image space/μm coefficient amplitude. δ can then be used to convert pⱼ to coefficient amplitudes:

$${dc}_{1 , 2} = {p}_{j} ( \frac{{S}_{px}}{δ} ) \qquad ( 15 )$$

where dc_{1,2} are the relative Zernike coefficient amplitudes for tip/tilt (units of μm) and Sₚₓ is the size of one pixel (units μm/pixel).

This computation is performed when calibrating the deformable mirror, and when using phase diversity to validate a calibration using the characterization assay. For the deformable mirror calibration, coefficient amplitudes as a function of actuator voltage are obtained for each of the 52 actuators using the object estimates obtained for each deformable mirror voltage pair. The slope value (units μm coefficient amplitude/V) that is used in the interaction matrix, IM_{(1,2),A} is given by Eqn. 16:

$${IM}_{( 1 , 2 ) , A} = \frac{{dc}_{1 , 2}}{{v}_{2} - {v}_{1}} \qquad ( 16 )$$

When validating the calibration using phase diversity, we find the relative displacements between an object estimate arising from the issued command and an object estimate associated with a reference wavefront without the command. Eqn. 16 is then applied to obtain the relative tip/tilt.

### Shack-Hartmann Operation

The SHWFS was controlled via the custom Lab VIEW program described above using WaveKit v4.3.2 SDK. For all experiments, the device was operated with an exposure time of 1 s. The processing pipeline to go from image data to Zernike coefficients was performed on-line using the Imagine Optic Wavekit software. First, the image data of the imaged bead was converted to wavefront slopes. Second, using the calibration data supplied with the device the slopes are converted to Zernike coefficients using the modal Zernike reconstruction parameter which outputs Zernike coefficients under the Wyant convention. To facilitate conversion to ANSI notation, we output 32 coefficients. Notation conversion was performed using custom Lab VIEW code and the resulting ANSI coefficients were cropped to the desired set of 20, including tip and tilt.

The procedures for performing a deformable mirror calibration and its validation were identical to the phase diversity version, except that instead of acquiring defocus steps and computing wavefronts using the PD algorithm, wavefronts were acquired directly using the SHWFS as described above.

### Control Matrix Validation

We used a characterization assay to quantitatively assess calibration performance for Zernike modes 1-20. Voltages corresponding to a 0.15 μm amplitude of each tested mode were added to the offset voltage and applied to the deformable mirror. Defocus diversity image stacks were acquired using the same axial defocus positions (±2 μm, ±1 μm, 0 μm), exposure time (30 ms) and image crop size (128×128) as for the deformable mirror calibration. Wavefront estimates from the resulting diversity defocus image stacks were obtained as for the calibration data. The phase diversity algorithm estimates modes 3-20 and tip/tilt were computed from the object estimate as described above. As the wavefront measurement may contain nonzero values corresponding to residual aberration, we acquired an additional reference wavefront by applying only the offset voltage to the deformable mirror and measuring this residual aberration. This reference wavefront was subtracted from each of the tested mode wavefronts to obtain the wavefront corresponding to the applied command for each mode.

When assessing calibration performance using the SHWFS, we applied Zernike modes 1-20 as above, then measured the resulting wavefront using the SHWFS. A reference wavefront with only the offset voltage applied to the deformable mirror was subtracted from the result using the Imagine Optic SDK.

For each applied mode, the error is determined based on the target value for the Zernike coefficients. For example, to validate mode 3 (oblique astigmatism), the expected Zernike coefficient amplitude is 0.15 μm for oblique astigmatism and zero for other coefficients. We computed the error for each influence function shown in FIG. 7C and its Shack-Hartmann counterpart by subtracting the target coefficients from the measured coefficients.

The control matrix generated by the calibration is sensitive to the orientation of the measurement device. As the detector and the SHWFS were mounted orthogonally with respect to each other, this change in orientation must be accounted for when validating calibrations which were originally acquired with a different modality. To perform a SHWFS validation of a control matrix generated using PD we first rotate the measured PD wavefronts −90° and then mirror them up-down to obtain the orientation corresponding to the SHWFS. Likewise, to use PD to validate a calibration acquired with the SHWFS we rotate the wavefront in the opposite direction (±90°) before mirroring up-down to obtain the orientation corresponding to the detector.

To assess errors across multiple calibrations we acquired 3 deformable mirror calibrations, each using a single bead located in a different field of view. For each acquired calibration (for both SHWFS- and PD-derived calibrations) we performed validation experiments using both sensing methods across 3 different fields of view, resulting in a total of 9 validations for each sensing method. Each validation consists of a 20×20 matrix of coefficients, yielding 400 points per validation for a total of N=3600 points each. Outliers were removed from validations using the generalized extreme Studentized deviate test for outliers with the MATLAB function rmoutliers, leaving a total of N=3543 for the SHWFS- and N=3581 for the PD-derived calibration.

### Root Mean Square Wavefront Distortion

Wavefront aberrations are stated in terms of root mean square wavefront distortion of phase computed across N pupil elements relative to a flat wavefront according to Eqn. 17.

$$RMS = \sqrt{\frac{1}{N} {\sum }_{n = 1}^{N} {\vert {ϕ}_{n} \vert}^{2}} \qquad ( 17 )$$

where fₙ is the phase for a given pupil position, and n is the pupil pixel index.

### Random Aberration Generation and Scaling

When choosing aberrations for testing AO correction, Zernike coefficients were randomly generated mode-by-mode, with a 30% chance for the selected mode to have a non-zero value. Tip, tilt, defocus, and modes >20 were excluded from selection. If selected, the random coefficient value R_{C} (in μm), was determined based on a variable amplitude, R_{A} via a random number between 0 and 1, R_{N}, according to Eqn. 18.

$${R}_{C} = {R}_{A} ( 2 {R}_{N} - 1 ) \qquad ( 18 )$$

Values of R_{C} thus ranged from ±R_{A}. We varied R_{A} between 0.1 to 0.8 when testing the effects of increasing aberration magnitude and R_{A} was fixed to 0.4 when applying random aberrations for cellular imaging tests.

In certain test cases, it was desirable to scale the magnitude of an aberration. The scaled coefficients, C_{sc} were obtained by multiplying each coefficient value C_{Z} by the ratio of the desired scaled wavefront RMS, RMS_{scaled} and the original wavefront RMS, RMS_{base}.

$${C}_{sc} = {C}_{Z} ( \frac{{RMS}_{scaled}}{{RMS}_{base}} ) \qquad ( 19 )$$

### AO Control Loop Software

AO correction was performed using a control loop implemented in the Lab VIEW software program described above. A ground truth image (i.e., no aberration and system aberrations corrected) was acquired prior to starting the loop procedure. The AO correction loop initialized by first generating and applying a random test aberration. The random aberration Zernike coefficients are then added to the diversity coefficients of each of the 5 total diversity phases. The four non-zero diversity phases consisted of pure horizontal or oblique astigmatism at ±1 μm amplitude. Summed coefficients were converted to deformable mirror voltages using the deformable mirror control matrix and added to the offset voltage, the set of voltages that served as the initial position for the deformable mirror, which were determined by removing system aberrations.

After applying the relevant voltages to the deformable mirror, we acquired an image corresponding to each diversity phase. The laser was shuttered after acquisition of all diversity phases is complete (to prevent excess photobleaching), and the image stack and diversity phase information was passed to MATLAB for estimating the wavefront. After estimation, MATLAB passed the object estimate and estimated coefficients back to Lab VIEW. These coefficients were converted to deformable mirror voltages using the control matrix and subtracted from the voltage previously applied for each phase. This process of acquisition, computation, and correction comprises one correction cycle. The process was repeated for a desired number of correction cycles.

### System Aberration Correction

The control loop described above can also be used to correct system aberrations. The primary difference in procedure is that for system aberration correction, no test aberrations are applied. Rather, an image is acquired, and the resulting wavefront sensed. Since this wavefront contains only system aberrations, we applied multiple correction cycles until the sensed wavefront error did not improve upon successive iterations. The voltages corresponding to the minimized wavefront error were saved and applied as the base voltage offset.

Axial views of 500 nm beads were acquired by applying the offset voltage to be tested (before or after correcting system aberrations) and acquiring a defocus image stack consisting of 101 image planes spaced 100 nm apart. Axial profiles were obtained using a binary mask to segment beads in the image area and computing the axial FWHM at the centroid of each segmented bead using the raw maximum intensity as the center position.

### Neural Representations of Wavefront Retrieval

In some implementations, the phase diversity techniques described herein can be used in conjunction with machine learning models to estimate a final image from a plurality of input images, where the input images include a raw image and at least one additional image that includes an intentional aberration, and an aberration in the raw image is reduced in the generated final image.

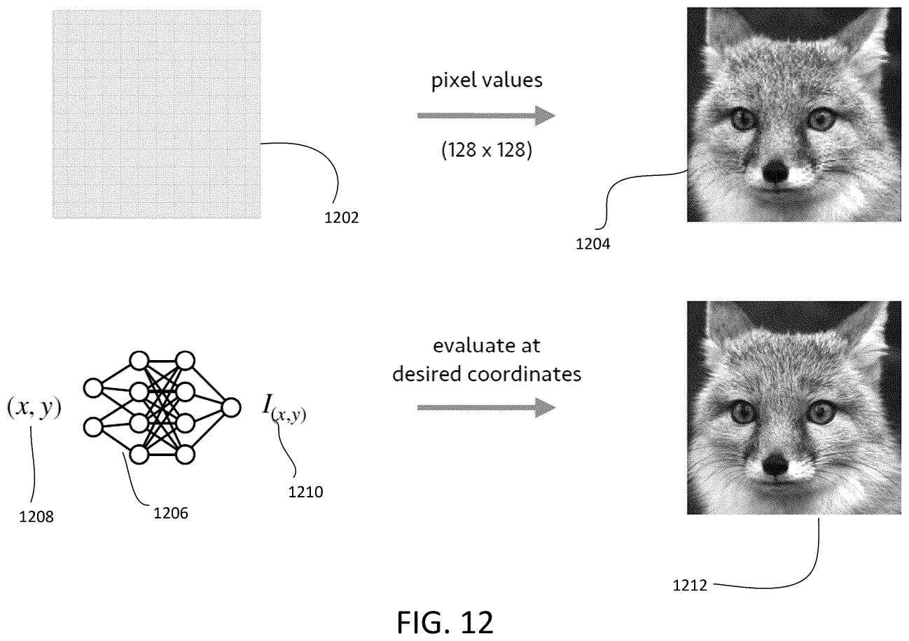

FIG. 12 is a schematic diagram illustrating processes for generating images from input data. For example, a traditional imaging process can include detecting intensities of light received from an object and imaged onto a detector that has a two-dimensional pixel grid 1202, and then generating an image 1204 that represents the imaged light. For example, the generated image can directly correlate the two-dimensional intensity data from the detector with a two-dimensional array of intensities provided in the generated image 1204. In some implementations, various filters can be applied to the two-dimensional intensity data from the detector to generate the image 1204. In some implementations, a machine learning model that may include for example, a neural network 1206 can be used to generate an image 1212 based on data 1208 that is input to the model and data that is used to train the model. The data 1208 that is input to the model can include, for example, the coordinates at which the image should be evaluated, and the output 1210 is the intensity data of an image of an object. The data used to train the model can be representative of, or associated with, image data of an object, either a single image or multiple images. The coordinates at which the image is being evaluated can be different from the pixel coordinates of the images used for training. In this manner, detailed features of the fox (e.g., the black whiskers extending from the nose of the fox) in the image 1212 can be enhanced as compared with the features in the image 1204.

Referring again to FIG. 3, an image d of an object can be represented as a convolution between the object f and the point spread function s(ϕ), d=f*s(ϕ), where ϕ represents a phase aberration. When imaging an unknown object f (302) that is subject to an aberration (304) having an unknown aberrated point spread function s(ϕ), the image d (306) of the object does not contain sufficient information to infer the unknown aberration. However, the phase diversity techniques described herein use the additional information of aberrated images d₁, . . . , dₖ (308₁ . . . 308ₖ) having known diversity aberrations θ₁, . . . , θₖ to estimate both the phase aberration ϕ and the unknown true object f, which then is used to generate unaberrated images of the object. Phase diversity-based machine learning models also use such an approach.

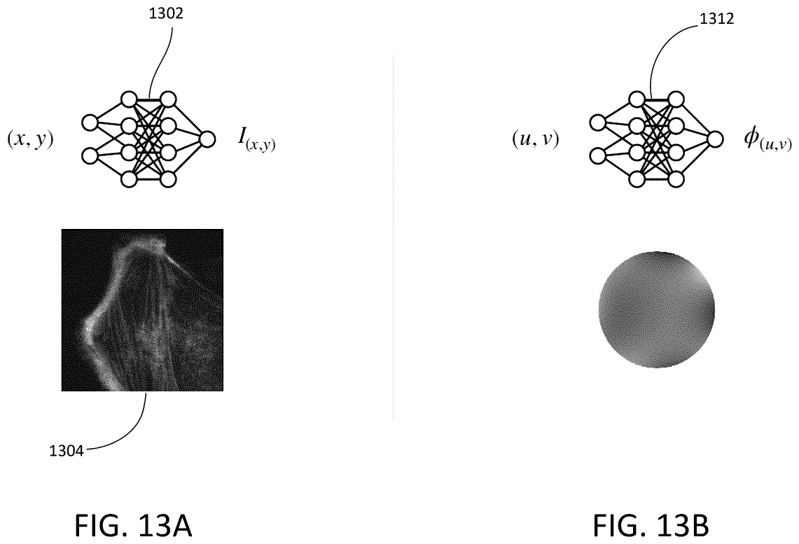

FIG. 13A is a schematic depiction of a process for generating an unaberrated image of an object using a trained machine learning model 1302. The model 1302 is trained to generate an unaberrated image 1304 of an object based on training data that includes an aberrated image of the object, where the aberration is unknown, and one or more additional images of the object, where the one or more additional images are subject to known aberrations. The trained model 1302 then is used to generate the unaberrated image of the object based on the image of the object that includes the unknown aberration.

FIG. 13B is a schematic depiction of a process for generating a phase map of an aberration present in an image of the object using a machine learning model 1312. The model 1312 is trained to generate the phase map based on training data that includes spatial frequency information of an aberrated image of the object, where the aberration is unknown, and spatial frequency information of one or more additional images of the object, where the one or more additional images are subject to known aberrations. The trained model 1312 then can be evaluated at spatial frequency coordinates to generate the phase map of the unknown aberration.

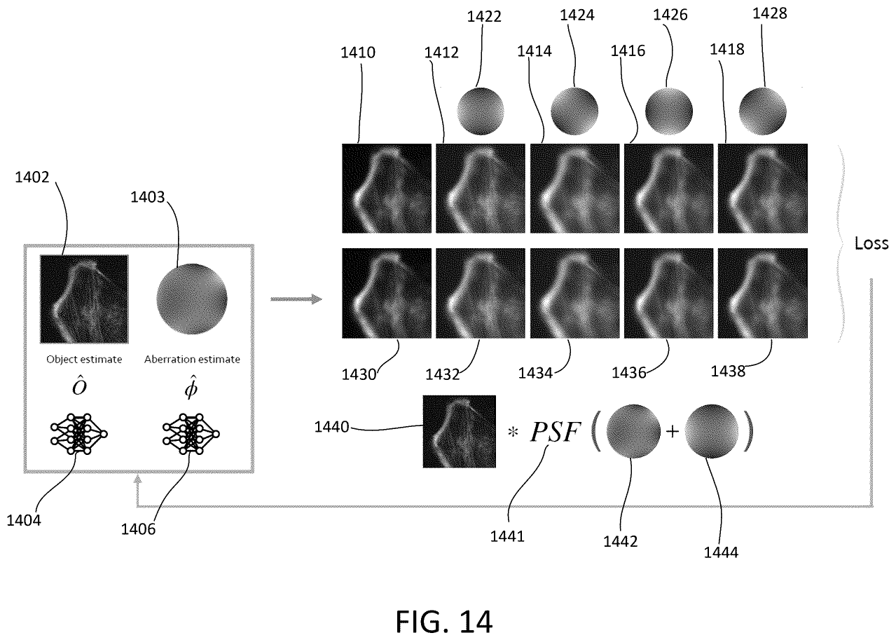

FIG. 14 is a schematic depiction of a process for generating an estimate of an object 1402 and an estimate of an aberration 1403 with machine learning models 1404 and 1406, respectively. Images of an object are collected, including an aberrated image 1410 of the object, where the aberration is unknown, and one or more (e.g., four or fewer) additional images 1412, 1414, 1416, 1418 of the object, where the additional images are subject to known aberrations 1422, 1424, 1426, 1428. The known aberrations can include aberrations characterized by one or more Zernike modes, for example, different astigmatism modes and/or a defocus mode, that are applied by a deformable mirror in the microscope system. Then, the images 1410, 1412, 1414, 1416, 1418 are used as training data to train machine learning models 1404, 1406 to generate estimates 1430, 1432, 1434, 1436, 1438 of the object, where the estimates 1430, 1432, 1434, 1436, 1438 are characterized as estimated unaberrated images 1440 of the object convolved by a point spread function 1441. For the estimated image 1430, the point spread function 1441 is based on the estimate of the unknown aberration 1442, and for the estimates 1432, 1434, 1436, 1438 the point spread function 1441 is based on the estimate of the unknown aberration 1442 plus a known aberration 1444, wherein the known aberration corresponds to the aberration used to generate the corresponding training data images 1412, 1414, 1416, 1418. The raw training data images 1410, 1412, 1414, 1416, 1418 are compared to the estimates generated by the machine learning models 1404, 1406, and new estimates are generated based on minimizing a loss function until performance of the models satisfies a performance criterion. As the model is trained, the estimates of the unaberrated image 1402 of the object and of the aberration 1403 of the object are improved, so that a high-resolution, unaberrated image 1402 of the object is generated.

In the implementation of FIGS. 12-14, the unaberrated image 1402 does not need to be generated by applying a corrective phase to the deformable mirror of the microscope system, for example, a phase that corrects for an existing unknown aberration in the system, and then re-imaging the object. Rather, the unaberrated image 1402 is generated by the trained machine learning models 1404, 1406 based on the images 1410, 1412, 1414, 1416, 1418, one of which includes an unknown aberration and at least one of which includes a known aberration.

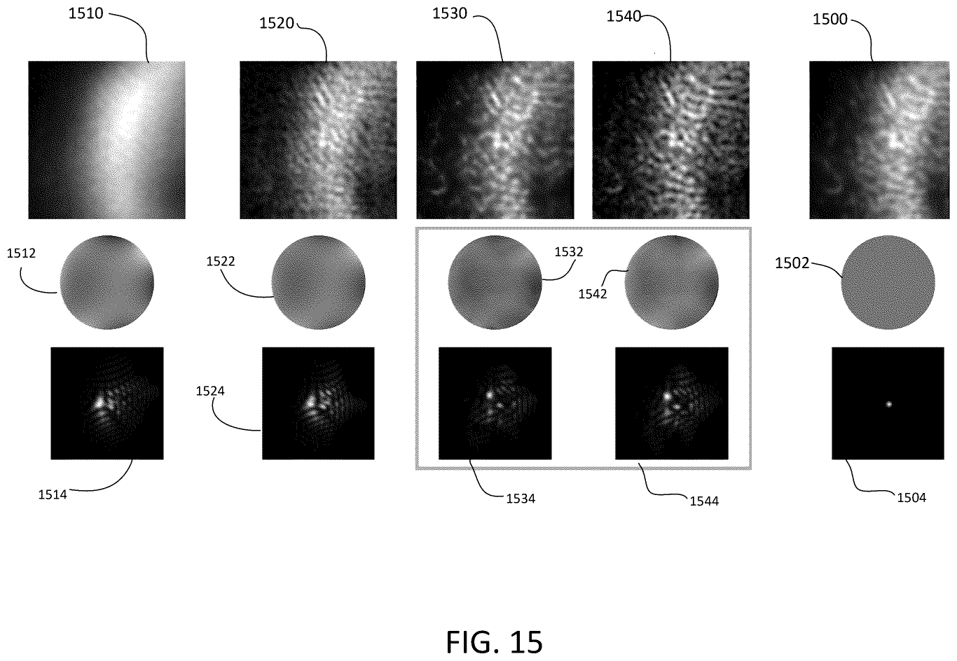

FIG. 15 is a schematic diagram illustrating different images produced using phase diversity-based adaptive optics techniques, along with the phase aberrations and point spread functions associated with the images. For example, an unaberrated image 1500 of an object, for which the phase aberration 1502 is flat has a point spread function 1504 that is a close approximation of a point as viewed through a diffraction-limited imaging system. An aberrated image 1510 of the object has phase aberration 1512 and a point spread function 1514 that is significantly spread out from a point. Phase diversity-adaptive optics techniques can be used to produce an estimate of the phase aberration 1522 of the aberrated image 1510, where the estimated phase aberration 1522 has a point spread function 1524. The estimated phase aberration 1522 then can be used to correct the phase aberration 1512 of the aberrated image 1510, for example, by applying a corrective deformation to a reflective surface of a deformable mirror within the imaging path, and this approach can produce a corrected image 1520.

In another implementation, phase diversity-adaptive optics techniques can be used to estimate the phase aberration of the aberrated image 1510 and to correct the phase aberration, for example, by training machine learning models to generate (or estimate) a corrected image and to estimate the aberration that caused distortion in the aberrated image 1510. For example, as explained above, a plurality of phase diversity images can be captured, in which each phase diversity image is based on the application of a known aberration to a deformable mirror of the optical system. Then, the machine learning models can be trained on the original aberrated image 1510 and the additional phase diversity images to produce an estimate of the object (e.g., a corrected, unaberrated image) and an estimate of the aberration that caused the distortion in the aberrated image 1510. In implementation, the machine learning models can be trained on the original aberrated image and the phase diversity images under the assumption that the phase diversity images are generated based on different known aberrations (e.g., corresponding to different Zernike modes). For example, in such an implementation, an image 1530 can be generated, and an estimated phase aberration 1532 having a corresponding point spread function 1534 can be generated. However, the deformable mirror may not perfectly replicate a Zernike mode or other such predetermined phase aberration. Therefore, in another implementation, the machine learning models can be trained on the original aberrated image and the phase diversity images under the assumption that the phase diversity images are generated based on different aberrations that are similar to different Zernike modes (or other predetermined aberrations) but with the models also being trained to estimate the actual phase aberrations applied by the deformable mirror to generate the phase diversity images. For example, in such an implementation, an image 1540 can be generated, and an estimated phase aberration 1542 having a corresponding point spread function 1544 can be generated, where generation of the image 1540 and the estimated phase aberration 1542 includes applying a trained machine learning model to the voltages used on the actuators of the deformable mirror to generate the phase diversity images to estimate the actual phase aberrations applied to the deformable mirror.

In addition to being used in widefield microscopy implementations to correct for aberrations in the light emitted from the sample, the phase diversity-based adaptive optics techniques described herein can be applied to excitation light that is provided by a microscope system to a sample to cause the emission of light from the sample, which is then imaged. Such microscopy systems can include, for example, point-scanning microscope systems (e.g., confocal microscopy systems, two-photon microscopy systems, etc.), line-scanning microscope systems, and light sheet microscope systems. The correction of aberrations of the excitation light can improve the resolution in images produced with such systems.

In one example, point-scanning microscopy systems rely on focusing light to a diffraction-limited point within a sample, detecting light emitted in response to the focused point of light, and assigning information associated with the detected light to the location of the point within the sample. Resolution of images generated from point-scanning microscopy systems depends on the spatial extent of the point of light within the sample, and therefore aberrations of the excitation light wavefront can degrade the resolution of the images. Thus, the phase diversity-based adaptive optics techniques described herein can be used to mitigate the effect of aberrations in the optical path of the excitation light to enhance the resolution of images generated in a point-scanning microscopy system.

For example, referring again to FIG. 4, the wavefront modulating element 420 can be placed in the optical path between the light source 402 and the objective 414 (and/or an additional wavefront modulating element can be added to this location of the optical path) at a position that is optically conjugate to the back pupil plane of the objective 414 and can be used to modify a wavefront of the excitation light provided by the light source 402 to the sample. In such an implementation, an aberrated image of an object in a sample (e.g., a point in the sample), which is subject to an unknown aberration, can be generated, and the wavefront modulating element can be used to introduce known aberrations to the excitation light in order to generate one or more phase diversity images. Then, the resulting phase diversity images, along with a raw aberrated image, can be used to determine the unknown aberration. The determined aberration then can be used to apply an adaptive optics correction, for example, by applying a corrective phase to the deformable mirror to modify a wavefront of the excitation light, and/or for example, by using one or more machine learning models to generate images of the object having higher resolution and reduced aberration, as compared with the original image that is subject to the unknown aberration. The corrective phase applied to the deformable mirror can be used to correct an aberration in the excitation light as a point of the excitation light is scanned over a region near the object from which the phase diversity images were collected, which were used to estimate an aberration of the excitation light focused on the object in the sample.

In some implementations, a number of different aberrations of the excitation light can be estimated for different objects (e.g., points) within a field of view of the sample but that are spatially separated from each other, and then the different aberrations can be averaged to produce an average aberration that can be used to apply an adaptive optics correction to a wavefront modulating element as a point of excitation light is scanned over the field of view in the sample.

In some implementations, a first wavefront modulating element can be included in the microscopy system on the excitation light side of the optical path (i.e., between the light source and the sample along the optical path) and a second wavefront modulating element can be included in the microscopy system on the emission light side of the optical path (i.e., between the sample and the detector along the optical path), and phase diversity-based adaptive optics techniques, as described herein, can be used to correct aberrations both in the excitation light and in the emission light. In some implementations, the first wavefront modulating element and the second wavefront modulating element can be the same element. For example, when fluorescence emission light emitted from the object is collected in epi-mode through the same objective that is used to focus excitation light into the sample, a single wavefront modulating element can be used to correct the aberrations in the excitation light and in the emission light.

The phase diversity AO correction techniques demonstrated herein can be extended to provide AO correction of 3D images of objects to improve the accuracy of wavefront sensing and subsequent correction on 3D biological samples, particularly if there is substantial out-of-focus light. Furthermore, more accurate modeling of the point spread function (PSF) or noise that characterizes the aberration to be corrected can be used to improve both wavefront sensing and object estimates. Also, while the experiments and demonstrations described herein consider a small field of view, over which aberrations were isoplanatic, imaging larger, more heterogeneous samples can be accomplished with tiling of different images of different adjacent, or overlapping, fields of view, with sensing and correction (or at least differing object estimates) applied for each tile, and in such cases, phase diversity-based AO correction can be applied to the different tiles. In addition, although the experiments and demonstrations described herein have focused on deformable mirror calibration and aberration correction, our phase diversity method can facilitate other methods that rely on wavefront sensing, such as remote refocusing. As described herein, approaches that use neural networks in conjunction with additional diversity images for wavefront sensing can be used in combination with a classical method like the phase diversity-based AO correction techniques described herein, e.g., for improved performance in highly aberrating tissue. In addition, the techniques described herein can be extended to other microscope systems that provide optical sectioning, including light sheet and confocal microscopy.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, solid state drives, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) or light emitting diode (LED) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback or notification, e.g., email or text message; and input from the user can be received in any form, including acoustic, speech, or tactile input, email or text message.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the implementations.

What is claimed is:

1. A microscope system for imaging a sample, the microscope system comprising:
a light source configured for generating a light beam;
an objective configured for receiving the generated light beam and imaging the light beam within the sample and for imaging light received from the sample in response to the light beam imaged within the sample;
a wavefront modulating element configured for modifying a wavefront of the light received from the sample to reduce aberrations of light emitted from the sample;
a detector configured for receiving the imaged light received from the sample, wherein the imaged light is imaged onto the detector, the detector being configured for generating images of the sample based on the light imaged onto the detector;
a processor configured to:
control the wavefront modulating element to introduce one or more known aberrations into at least one image of the sample;
based on at least two generated images of the sample, wherein the generated images include a raw image and at least one image that includes a known aberration, estimate an aberration of a wavefront of light emitted from the sample;
control the wavefront modulating element to modulate the wavefront of light emitted from the sample, such that the estimated aberration of the wavefront of light emitted from the sample is reduced.

2. The microscope system of claim 1, wherein the wavefront modulating element includes a deformable mirror having multiple electro-mechanical actuators, each actuator being configured to locally deform a portion of a surface of the deformable mirror, and wherein controlling the wavefront modulating element to introduce the one or more known aberrations includes determining a phase aberration to introduce through the deformable mirror and mapping the determined phase aberration to voltages to apply to the multiple electro-mechanical actuators of the deformable mirror to produce the determined phase aberration.

3. The microscope system of claim 2, wherein each of the multiple electro-mechanical actuators is associated with an influence function characterizing its effect on a reflective surface of the mirror as a function of a voltage applied to the electro-mechanical actuator, and wherein mapping the determined phase aberration to voltages to apply to the multiple electro-mechanical actuators includes determining the voltages based on a linear combination of influence functions of the multiple electro-mechanical actuators.

4. The microscope system of claim 2, wherein each of the multiple electro-mechanical actuators is associated with an influence function characterizing its effect on a reflective surface of the mirror as a function of a voltage applied to the electro-mechanical actuator, and wherein mapping the determined phase aberration to voltages to apply to the multiple electro-mechanical actuators includes applying a trained machine learning model to the determined phase aberration to determine the voltages.

5. The microscope system of claim 1,
wherein the one or more known aberrations include one or more Zernike modes, and
wherein controlling the wavefront modulating element to modulate the wavefront of light emitted from the sample, such that the estimated aberration of the wavefront of light emitted from the sample is reduced, includes applying a phase correction to the wavefront modulating element, the phase correction being generated from a linear combination of one or more Zernike modes.

6. A microscope system for imaging a sample, the microscope system comprising:
a light source configured for generating a light beam;
an objective configured for receiving the generated light beam and imaging the light beam within the sample and for imaging light received from the sample in response to the light beam imaged within the sample;
a wavefront modulating element configured for modifying a wavefront of the light received from the sample to reduce aberrations of light emitted from the sample;
a detector configured for receiving the imaged light received from the sample, wherein the imaged light is imaged onto the detector, the detector being configured for generating images of the sample based on the light imaged onto the detector;
a processor configured to:
control the system to introduce one or more known aberrations into at least one image of the sample;
based on at least two generated images of the sample, the generated images including a raw image and at one least image including a known aberration, estimate an aberration of a wavefront of light emitted from the sample;
reduce an aberration in the raw image based on the estimated aberration.

7. The microscope system of claim 6, wherein the one or more known aberrations include one or more Zernike modes.

8. The microscope system of claim 6, wherein the wavefront modulating element includes a deformable mirror having multiple electro-mechanical actuators, each actuator being configured to locally deform a portion of a surface of the deformable mirror, and wherein controlling the system to introduce the one or more known aberrations includes determining a phase aberration to introduce through the deformable mirror and mapping the determined phase aberration to voltages to apply to the multiple electro-mechanical actuators of the deformable mirror to produce the determined phase aberration.

9. The microscope system of claim 8, wherein each of the multiple electro-mechanical actuators is associated with an influence function characterizing its effect on a reflective surface of the mirror as a function of a voltage applied to the electro-mechanical actuator, and wherein mapping the determined phase aberration to voltages to apply to the multiple electro-mechanical actuators includes applying a trained machine learning model to the determined phase aberration to determine the voltages.

10. The microscope of system claim 9, wherein the processor is further configured to train a machine learning model to estimate an object in the sample based on the at least two generated images of the sample, and to generate an image of the object based on evaluating the trained machine learning model at spatial coordinates.

11. The microscope system of claim 9, wherein the processor is further configured to:
train a first machine learning model to estimate an actual aberration introduced into the at least one image of the sample in response to the control of the system by the processor,
apply the first trained machine learning model to the voltages applied to the actuators for the at least one image to generate an estimated actual aberration introduced into the at least one image of the sample,
train a second machine learning model to estimate an object of the sample based on the at least two generated images of the sample and based on the estimated actual aberration, and
evaluate the second trained machine learning model at spatial coordinates to generate an image of the object.

12. A microscope system for imaging a sample, the microscope system comprising:
a light source configured for generating a light beam;
a first wavefront modulating element configured for modifying a wavefront of the generated light beam;
an objective configured for receiving the modified wavefront of the generated light beam and for focusing the modified wavefront of the generated light beam within the sample and for imaging light received from the sample in response to the light beam focused within the sample;
a detector configured for receiving the imaged light received from the sample, wherein the imaged light is imaged onto the detector, the detector being configured for generating images of the sample based on the light imaged onto the detector;
a processor configured to:
control the system to introduce one or more known aberrations into at least one image of the sample;
based on at least two generated images of the sample, wherein the generated images include a raw image and at least one image that includes a known aberration, estimate an aberration of a wavefront of light focused within the sample;
control the first wavefront modulating element to modulate the wavefront of light focused within the sample, such that the estimated aberration of the wavefront of light focused within the sample is reduced.

13. The microscope system of claim 12, wherein the first wavefront modulating element is selected from the group consisting of a deformable mirror and a spatial light modulator.

14. The microscope system of claim 12, wherein the first wavefront modulating element includes a deformable mirror having multiple electro-mechanical actuators, each actuator being configured to locally deform a portion of a surface of the deformable mirror, and wherein controlling the system to introduce the one or more known aberrations includes determining a phase aberration to introduce through the deformable mirror and mapping the determined phase aberration to voltages to apply to the multiple electro-mechanical actuators of the deformable mirror to produce the determined phase aberration.

15. The microscope system of claim 12, wherein controlling the first wavefront modulating element to modulate the wavefront of light emitted from the sample, such that the estimated aberration of the wavefront of light emitted from the sample is reduced, includes applying a phase correction to the first wavefront modulating element, the phase correction being generated from a linear combination of one or more Zernike modes.

16. The microscope system of claim 12, further comprising:
a second wavefront modulating element configured for modifying a wavefront of the light received from the sample,
wherein the processor is further configured to:
control the second wavefront modulating element to modulate the wavefront of light received from the sample, such that the estimated aberration of the wavefront of light received from the sample is reduced.

17. A microscope system for imaging a sample, the microscope system comprising:
a light source configured for generating a light beam;
a wavefront modulating element configured for modifying a wavefront of the generated light beam;
an objective configured for receiving the modified wavefront of the generated light beam and focusing the modified wavefront of the generated light beam within the sample and for imaging light received from the sample in response to the light beam focused within the sample;
a detector configured for receiving the imaged light received from the sample, wherein the imaged light is imaged onto the detector, the detector being configured for generating images of the sample based on the light imaged onto the detector;
a processor configured to:
control the system to introduce one or more known aberrations into at least one image of the sample;
based on at least two generated images of the sample, the generated images including a raw image and at one least image including a known aberration, estimate an aberration of a wavefront of light emitted from the sample;
reduce an aberration in the raw image based on the estimated aberration.

18. The microscope system of claim 17, wherein the wavefront modulating element includes a deformable mirror having multiple electro-mechanical actuators, each actuator being configured to locally deform a portion of a surface of the deformable mirror, and wherein controlling the system to introduce the one or more known aberrations includes determining a phase aberration to introduce through the deformable mirror and mapping the determined phase aberration to voltages to apply to the multiple electro-mechanical actuators of the deformable mirror to produce the determined phase aberration.

19. The microscope system of claim 18, wherein each of the multiple electro-mechanical actuators is associated with an influence function characterizing its effect on a reflective surface of the mirror as a function of a voltage applied to the electro-mechanical actuator, and wherein mapping the determined phase aberration to voltages to apply to the multiple electro-mechanical actuators includes applying a trained machine learning model to the determined phase aberration to determine the voltages.

20. The microscope system of claim 17, wherein the processor is further configured to train a machine learning model to estimate an object of the sample based on the at least two generated images of the sample, and to generate an image of the object based on evaluating the trained machine learning model at spatial coordinates.

21. The microscope system of claim 17, wherein the processor is further configured to:
train a first machine learning model to estimate an actual aberration introduced into the at least one image of the sample in response to the control of the system by the processor,
apply the first trained machine learning model to the voltages applied to the actuators for the at least one image to generate an estimated actual aberration introduced into the at least one image of the sample,
train a second machine learning model to estimate an object of the sample based on the at least two generated images of the sample and based on the estimated actual aberration, and
evaluate the second trained machine learning model at spatial coordinates to generate an image of the object.
